(19) United States
(12) Patent Application Publication
(10) Pub. No.: US 2026/0295528 A1
(43) Pub. Date: Oct. 1, 2026

(54) AN EXHAUST GAS TREATMENT SYSTEM FOR TREATING AN EXHAUST GAS STREAM EXITING A GASOLINE ENGINE

(71) Applicant: BASF Mobile Emissions Catalysts LLC, lselin, NJ (US)

(72) Inventors: Karifala DUMBUYA, Hannover (DE); Holger SCHWEKENDIEK, Hannover (DE); Markus KINNE, Hannover (DE); Matthew T. CAUDLE, Iselin, NJ (US)

(21) Appl. No.: 18/880,075

(22) PCT Filed: Jul. 3, 2023
(86) PCT No.: PCT/EP2023/068198

§ 371 Date: Dec. 30, 2024

(30) Foreign Application Priority Data
Jul. 4, 2022 (EP) 22182837.9

(51) Int. Cl. B01D 53/94; F01N 3/10; F01N 3/20; F01N 13/00

(52) U.S. Cl. CPC B01D 53/9477; B01D 53/9436; B01D 53/9445; F01N 3/101; F01N 3/2066; F01N 13/009; B01D 2255/1021; B01D 2258/014

(57) ABSTRACT

The present invention relates to an exhaust gas treatment system for treating an exhaust gas stream exiting a gasoline engine, the system comprising a first catalyst, namely a three-way conversion catalyst, a second catalyst, namely a four-way conversion catalyst and a third catalyst comprising a SCR coating. The present invention further relates to a method for treating an exhaust gas stream exiting a gasoline engine using said exhaust gas treatment system.

The present invention relates to an exhaust gas treatment system for treating an exhaust gas stream exiting a gasoline engine and a method for treating an exhaust gas stream exiting a gasoline engine using said exhaust gas treatment system.

Emission regulations for exhaust gas from mobile gasoline applications have been increasingly stringent in the past and will presumably lead to even stricter regulations in the future. Accordingly, more effective exhaust gas treatment systems for automotives will be required in the coming years. Efficient ways of removing the main pollutants from gasoline engines including nitrogen oxides (NOx), unburned hydrocarbons (HC), carbon monoxide (CO) and particulate matter have been developed and commercialized in the past based on the so-called three way conversion catalysts (TWC) or four way conversion catalysts (FWC).

However, it is possible that future emission regulations could also impose stricter limits to secondary emissions from exhaust gas. For instance, more stringent European emission standards like EURO 7 or comparable regulations in the US may impose restrictions to ammonia (NH₃), hydrocarbon (HC) and carbon monoxide (CO) tailpipe emissions.

Studies have shown that such components have a detrimental effect on humans, ecosystems and vegetation. Therefore, there is a need to provide improved exhaust gas treatment systems which permits to reduce the ammonia (NH₃), hydrocarbon (HC) and carbon monoxide (CO) tailpipe emissions.

Therefore, it was an object of the present invention to provide an improved exhaust gas treatment system for treating an exhaust gas stream exiting a gasoline engine which permits to reduce the ammonia (NH₃), hydrocarbon (HC) and/or carbon monoxide (CO) tailpipe emissions compared to systems according to the prior art such as, e.g., EURO 6 or other systems. In addition to improved ammonia tailpipe emissions, it was found that the system of the present invention contributes significantly to HC emissions reduction derived mainly from robust low temperature HC light-off activity.

Therefore, the present invention relates to an exhaust gas treatment system for treating an exhaust gas stream exiting a gasoline engine, said exhaust gas treatment system having an upstream end for introducing said exhaust gas stream into said exhaust gas treatment system, wherein said exhaust gas treatment system comprises
(i) a first catalyst, being a three-way conversion catalyst, having an inlet end and an outlet end and comprising a coating disposed on a substrate, wherein the coating comprises a platinum group metal component supported on a porous oxidic material;
(ii) a second catalyst, being a four-way conversion catalyst, having an inlet end and an outlet end and comprising a coating disposed on a wall flow filter substrate, wherein the coating comprises a platinum group metal component supported on a porous oxidic material;
(iii) a third catalyst having an inlet end and an outlet end, wherein the third catalyst comprises a substrate and a coating for the selective catalytic reduction of NOx, wherein the SCR coating comprises a zeolitic material comprising one or more of Fe and Cu, wherein at most 0.0001 weight-% of said SCR coating consist of platinum group metal;
wherein the first catalyst according to (i) is the first catalyst of the exhaust gas treatment system downstream of the upstream end of the exhaust gas treatment system and
wherein the inlet end of the first catalyst is arranged upstream of the outlet end of the first catalyst;
wherein in the exhaust gas treatment system, the second catalyst according to (ii) is located downstream of the first catalyst according to (i) and wherein the inlet end of the second catalyst is arranged upstream of the outlet end of the second catalyst;
wherein in the exhaust gas treatment system, the third catalyst according to (iii) is located downstream of the second catalyst according to (ii) and wherein the inlet end of the third catalyst is arranged upstream of the outlet end of the third catalyst.

Preferably, the outlet end of the first catalyst according to (i) is in fluid communication with the inlet end of the second catalyst according to (ii) and wherein between the outlet end of the first catalyst according to (i) and the inlet end of the second catalyst according to (ii), no catalyst for treating the exhaust gas stream exiting the first catalyst is located in the exhaust gas treatment system.

Preferably, the outlet end of the second catalyst according to (ii) is in fluid communication with the inlet end of the third catalyst according to (iii) and wherein between the outlet end of the second catalyst according to (ii) and the inlet end of the third catalyst according to (iii), no catalyst for treating the exhaust gas stream exiting the second catalyst is located in the exhaust gas treatment system.

### First Catalyst

Preferably, the platinum group metal component of the coating of the first catalyst comprises one or more of Pd, Rh and Pt, more preferably one or more of Pd and Rh, more preferably Pd and Rh.

Preferably, the coating of the first catalyst comprises the platinum group metal component at a loading, calculated as elemental platinum group metal, in the range of from 1 to 200 g/ft³, more preferably in the range of from 20 to 180 g/ft³, more preferably in the range of from 50 to 150 g/ft³.

Preferably, the porous oxidic material supporting the platinum group metal component of the coating of the first catalyst is selected from the group consisting of alumina, ceria, silica, zirconia, titania, a mixture of two or more thereof and a mixed oxide of two or more thereof, more preferably selected from the group consisting of alumina, titania, zirconia, a mixture of two or more thereof and a mixed oxide of two or more thereof, more preferably selected from the group consisting of alumina, zirconia, a mixture of two thereof, and a mixed oxide of two thereof, more preferably alumina.

Preferably, the first catalyst comprises the porous oxidic material of the coating in an amount in the range of from 0.2 to 4.0 g/in³, more preferably in the range of from 0.3 to 3.0 g/in³, more preferably in the range of from 0.4 to 2.5 g/in³, and even more preferably in the range of from 0.5 to 2.0 g/in³.

Preferably, the coating of the first catalyst further comprises an oxygen storage component, the oxygen storage component more preferably comprises cerium, more preferably comprises one or more of a cerium oxide, a mixture of oxides comprising a cerium oxide and a mixed oxide comprising cerium, wherein the mixed oxide comprising cerium more preferably additionally comprises one or more of zirconium, yttrium, neodymium, lanthanum, hafnium, samarium and praseodymium, more preferably one or more of zirconium, yttrium, neodymium, lanthanum, and praseodymium, more preferably zirconium.

Preferably, the oxygen storage component of the coating of the first catalyst comprises a mixed oxide comprising cerium and zirconium.

Preferably from 95 to 100 weight-%, more preferably from 98 to 100 weight-%, more preferably from 99 to 100 weight-%, more preferably from 99.5 to 100 weight-% of said oxygen storage component consist of a mixed oxide comprising cerium and zirconium.

Preferably from 10 to 60 weight-%, more preferably from 20 to 60 weight-%, more preferably from 20 to 50 weight-%, of the oxygen storage component consist of cerium, calculated as CeO₂, and preferably from 20 to 90 weight-%, more preferably from 40 to 70 weight-%, more preferably from 50 to 70 weight-%, of the oxygen storage component consist of zirconium, calculated as ZrO₂. Preferably from 0 to 20 weight-%, more preferably from 0 to 10 weight-% of the OSC consists of lanthanum and yttrium, calculated as La₂O₃ and Y₂O₃.

Preferably, the coating of the first catalyst comprises the oxygen storage component at a loading in the range of from 0.3 to 5 g/in³, more preferably in the range of from 0.4 to 3.5 g/in³ , more preferably in the range of from 0.45 to 3.0 g/in³, more preferably in the range of from 0.5 to 2.5 g/in³.

Preferably, in the coating of the first catalyst, the weight ratio of the porous oxidic material relative to the oxygen storage component as defined in the foregoing is in the range of from 1:1 to 10:1, more preferably in the range of from 1:1 to 5:1.

In the context of the present invention, it is conceivable that the platinum group metal of the first catalyst be also supported on the oxygen storage component.

Preferably, the coating of the first catalyst further comprises a non-zeolitic oxidic material, the non-zeolitic oxidic material more preferably comprises one or more of zirconia, alumina, ceria, titania, silica, and a mixed oxide comprising two or more of Zr, Al, Ce, Ti, and Si, more preferably comprises one or more of zirconia, alumina, ceria and silica, more preferably comprises zirconia.

Preferably, the coating of the first catalyst comprises the non-zeolitic oxidic material in an amount, calculated as the oxide, in the range of from 0.5 to 12 weight-%, more preferably in the range of from 1 to 10 weight-%, more preferably in the range of from 1 to 5 weight-%, based on the weight of the coating of the first catalyst.

Preferably, the coating of the first catalyst further comprises an oxide of an alkaline earth metal, the alkaline earth metal more preferably being selected from the group consisting of barium, strontium and magnesium, more preferably being selected from the group consisting of barium and strontium, more preferably being barium.

Preferably, the coating of the first catalyst comprises the oxide of the alkaline earth metal in an amount in the range of from 0.5 to 15 weight-%, more preferably in the range of from 1 to 10 weight-%, more preferably in the range of from 1 to 6 weight-%, based on the weight of the coating of the first catalyst.

Preferably, the coating of the first catalyst comprises a platinum group metal component supported on a porous oxidic material, more preferably an oxygen storage component as defined in the foregoing, more preferably a non-zeolitic oxidic material as defined in the foregoing, and more preferably an oxide of an alkaline earth metal as defined in the foregoing.

Preferably from 98 to 100 weight-%, more preferably from 99 to 100 weight-%, more preferably from 99.5 to 100 weight-%, more preferably from 99.9 to 100 weight-%, of the coating of the first catalyst consist of a platinum group metal component supported on a porous oxidic material, more preferably an oxygen storage component as defined in the foregoing, more preferably a non-zeolitic oxidic material as defined in the foregoing, and more preferably an oxide of an alkaline earth metal as defined in the foregoing. More preferably, the coating of the first catalyst consists of a platinum group metal component supported on a porous oxidic material, more preferably an oxygen storage component as defined in the foregoing, more preferably a non-zeolitic oxidic material as defined in the foregoing, and more preferably an oxide of an alkaline earth metal as defined in the foregoing.

Preferably, the substrate of the first catalyst is a flow through substrate, more preferably a ceramic flow through substrate.

Preferably, the ceramic substrate is made of any suitable refractory material, such as cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

Preferably, the first catalyst consists of the substrate and the coating.

Preferably, the coating of the first catalyst extends over 98 to 100 %, more preferably over 99 to 100%, more preferably over 99.5 to 100%, of the substrate axial length. The coating is preferably disposed on the substrate of the first catalyst.

Preferably the first catalyst comprises the coating at a loading in the range of from 1 to 7 g/in³, more preferably in the range of from 1.5 to 5 g/in³, more preferably in the range of from 2 to 3.5 g/in³.

### Second Catalyst

Preferably, the platinum group metal component of the coating of the second catalyst comprises one or more of Pd, Rh and Pt, more preferably one or more of Pd and Rh, more preferably Pd and Rh.

Preferably, the coating of the second catalyst comprises the platinum group metal component at a loading, calculated as elemental platinum group metal, in the range of from 1 to 100 g/ft³, more preferably in the range of from 3 to 80g/ft³, more preferably in the range of from 4 to 50 g/ft³.

Preferably, the porous oxidic material supporting the platinum group metal component of the coating of the second catalyst is selected from the group consisting of alumina, ceria, silica, zirconia, titania, a mixture of two or more thereof and a mixed oxide of two or more thereof, more preferably selected from the group consisting of alumina, titania, zirconia, a mixture of two or more thereof and a mixed oxide of two or more thereof, more preferably selected from the group consisting of alumina, zirconia, a mixture of two thereof, and a mixed oxide of two thereof, more preferably alumina.

Preferably, the second catalyst comprises the porous oxidic material of the coating in an amount in the range of from 0.5 to 2.5 g/in³, more preferably in the range of from 0.6 to 2.0 g/in³, more preferably in the range of from 0.7 to 1.5 g/in³, more preferably in the range of from 0.8 to 1.2 g/in³.

Preferably, the coating of the second catalyst further comprises an oxygen storage component (OSC), the oxygen storage component more preferably comprises cerium, more preferably comprises one or more of a cerium oxide, a mixture of oxides comprising a cerium oxide and a mixed oxide comprising cerium, wherein the mixed oxide comprising cerium more preferably additionally comprises one or more of zirconium, yttrium, neodymium, lanthanum, hafnium, samarium and praseodymium, more preferably one or more of zirconium, yttrium, neodymium, lanthanum, and praseodymium, more preferably zirconium.

Preferably, the oxygen storage component of the coating of the second catalyst comprises a mixed oxide comprising cerium and zirconium.

Preferably from 95 to 100 weight-%, more preferably from 98 to 100 weight-%, more preferably from 99 to 100 weight-%, more preferably from 99.5 to 100 weight-% of said oxygen storage component consist of a mixed oxide comprising cerium and zirconium.

Preferably from 10 to 60 weight-%, more preferably from 20 to 60 weight-%, more preferably from 20 to 50 weight-%, of the oxygen storage component consist of cerium, calculated as CeO², and more preferably from 20 to 90 weight-%, more preferably from 40 to 70 weight-%, more preferably from 50 to 70 weight-%, of the oxygen storage component consist of zirconium, calculated as ZrO². Preferably from 0 to 20 weight-%, more preferably from 0 to 10 weight-% of the OSC consists of lanthanum and yttrium, calculated as La₂O₃ and Y₂O₃. More preferably the OSC comprises lanthanum and yttrium in addition to cerium and zirconium.

Preferably, the coating of the second catalyst comprises the oxygen storage component at a loading in the range of from 1.5 to 2.5 g/in³, more preferably in the range of from 1.2 to 2.2 g/in³, more preferably in the range of from 1.0 to 2.0 g/in³, more preferably in the range of from 1 to 1.75 g/in³.

Preferably, in the coating of the second catalyst, the weight ratio of the porous oxidic material relative to the oxygen storage component as defined in the foregoing is in the range of from 1:1 to 0.5:1, more preferably in the range of from 1:1 to 0.25:1.

In the context of the present invention, it is conceivable that the platinum group metal of the first catalyst be also supported on the oxygen storage component.

Preferably, the coating of the second catalyst further comprises a non-zeolitic oxidic material, the non-zeolitic oxidic material more preferably comprises one or more of zirconia, alumina, ceria, titania, silica, and a mixed oxide comprising two or more of Zr, Al, Ce, Ti, and Si, more preferably comprises one or more of zirconia, alumina, ceria and silica, more preferably comprises zirconia.

Preferably, the coating of the second catalyst comprises the non-zeolitic oxidic material in an amount, calculated as the oxide, in the range of from 0.5 to 12 weight-%, more preferably in the range of from 1 to 10 weight-%, more preferably in the range of from 1 to 5 weight-%, based on the weight of the coating of the first catalyst.

Preferably, the coating of the second catalyst further comprises an oxide of an alkaline earth metal, the alkaline earth metal more preferably being selected from the group consisting of barium, strontium and magnesium, more preferably being selected from the group consisting of barium and strontium, more preferably being barium.

Preferably, the coating of the second catalyst comprises the oxide of the alkaline earth metal in an amount in the range of from 0.5 to 15 weight-%, more preferably in the range of from 1 to 10 weight-%, more preferably in the range of from 1 to 6 weight-%, based on the weight of the coating of the first catalyst.

Preferably, the coating of the second catalyst consist of a platinum group metal component supported on a porous oxidic material, more preferably an oxygen storage component as defined in the foregoing, more preferably a non-zeolitic oxidic material as defined in the foregoing, and more preferably an oxide of an alkaline earth metal as defined in the foregoing.

Preferably from 98 to 100 weight-%, more preferably from 99 to 100 weight-%, more preferably from 99.5 to 100 weight-%, more preferably from 99.9 to 100 weight-%, of the coating of the second catalyst consist of a platinum group metal component supported on a porous oxidic material, more preferably an oxygen storage component as defined in the foregoing, more preferably a non-zeolitic oxidic material as defined in the foregoing, and more preferably an oxide of an alkaline earth metal as defined in the foregoing. More preferably, the coating of the second catalyst consist of a platinum group metal component supported on a porous oxidic material, more preferably an oxygen storage component as defined in the foregoing, more preferably a non-zeolitic oxidic material as defined in the foregoing, and more preferably an oxide of an alkaline earth metal as defined in the foregoing.

Preferably, the substrate of the second catalyst is a ceramic wall flow filter substrate.

Preferably, the ceramic substrate is made of any suitable refractory material, such as cordierite, cordierite-alpha-alumina, aluminum titanate, silicon titanate, silicon carbide, silicon nitride, zircon mullite, spodumene, alumina-silica-magnesia, zircon silicate, sillimanite, a magnesium silicate, zircon, petalite, alpha-alumina, an aluminosilicate and the like.

### Preferably, the Second Catalyst Consists of the Substrate and the Coating.

Preferably, the coating of the second catalyst extends over 98 to 100 %, preferably over 99 to 100%, more preferably over 99.5 to 100%, of the substrate axial length. The coating is preferably disposed on the substrate of the second catalyst.

Preferably the second catalyst comprises the coating at a loading in the range of from 0.5 to 3 g/in³, more preferably in the range of from 0.75 to 2.5 g/in³, more preferably in the range of from 1.0 to 1.75 g/in³.

Preferably, there is no catalyst between the first catalyst according to (i) and the second catalyst according to (ii). Indeed, it is preferred that no other catalyst be present between the three-way conversion catalyst according to (i) and the four-way conversion catalyst according to (ii).

### Third Catalyst

Preferably, the zeolitic material comprised in the SCR coating of the third catalyst is a 12-membered ring pore zeolitic material, wherein the 12-membered ring pore zeolitic material more preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU. More preferably, the 12-membered ring pore zeolitic material comprised in the SCR coating of the third catalyst has a framework type BEA.

Preferably, the zeolitic material comprised in the SCR coating of the third catalyst is a 12-membered ring pore zeolitic material, the zeolitic material comprising Fe, wherein the 12-membered ring pore zeolitic material more preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU. More preferably, the 12-membered ring pore zeolitic material comprised in the SCR coating of the third catalyst has a framework type BEA.

Preferably, from 95 to 100 weight-%, more preferably from 98 to 100 weight-%, more preferably from 99 to 100 weight-%, more preferably from 99.5 to 100 weight-%, of the framework structure of the 12-membered ring pore zeolitic material comprised in the SCR coating of the third catalyst consist of Si, Al, and O, wherein in the framework structure, the molar ratio of Si to Al, calculated as molar SiO₂:Al₂O₃, is more preferably in the range of from 2:1 to 40:1, more preferably in the range of from 3:1 to 30:1, more preferably in the range of from 4:1 to 20:1, more preferably in the range of from 6:1 to 15:1.

Preferably, the zeolitic material comprised in the SCR coating of the third catalyst comprises iron, wherein the amount of iron comprised in the zeolitic material, calculated as Fe₂O₃, is more preferably in the range of from 0.1 to 10.0 weight-%, more preferably in the range of from 0.5 to 8 weight-%, more preferably in the range of from 1.5 to 7.5 weight-%, based on the total weight of the zeolitic material.

Preferably, the zeolitic material is free of Cu.

Preferably, the SCR coating of the third catalyst further comprises a non-zeolitic oxidic material, wherein the non-zeolitic oxidic material more preferably comprises one or more of zirconia, alumina, ceria, titania, silica, and a mixed oxide comprising two or more of Zr, Al, Ce, Ti, and Si, more preferably comprises one or more of zirconia, alumina, ceria and silica.

Preferably, the SCR coating of the third catalyst comprises the non-zeolitic oxidic material in an amount, calculated as the oxide, in the range of from 0.5 to 12 weight-%, more preferably in the range of from 1 to 10 weight-%, more preferably in the range of from 1 to 6 weight-%, based on the weight of the SCR coating of the third catalyst.

Preferably, at most 0.00001 weight-% of the SCR coating of the third catalyst consist of a platinum group metal, wherein more preferably from 0 to 0.00001 weight-% of the SCR coating of the third catalyst consist of platinum group metal.

In other words, preferably, the coating of the third catalyst is substantially free, more preferably free of, platinum group metal.

Preferably, the substrate of the third catalyst is a flow through substrate, more preferably a ceramic flow through substrate.

Preferably, the ceramic substrate is made of any suitable refractory material, such as cordierite, cordierite-alpha-alumina, aluminum titanate, silicon titanate, silicon carbide, silicon nitride, zircon mullite, spodumene, alumina-silica-magnesia, zircon silicate, sillimanite, a magnesium silicate, zircon, petalite, alpha-alumina, an aluminosilicate and the like.

Preferably from 98 to 100 weight-%, more preferably from 99 to 100 weight-%, more preferably from 99.5 to 100 weight-%, more preferably from 99.9 to 100 weight-%, of the SCR coating of the third catalyst consist of a zeolitic material comprising one or more of Fe and Cu, and more preferably a non-zeolitic oxidic material as defined in the foregoing.

### Third Catalyst: SCR Catalyst

Preferably, the third catalyst consists of the substrate and the SCR coating.

Preferably, the SCR coating of the third catalyst extends over 98 to 100 %, more preferably over 99 to 100%, more preferably over 99.5 to 100%, of the substrate axial length. The SCR coating is preferably disposed on the substrate of the third catalyst.

Preferably, the SCR coating comprises, more preferably consists of, a zeolitic material, more preferably having a framework type BEA, comprising iron and a non-zeolitic oxidic material, more preferably zirconia.

### Third Catalyst: SCR/AMOx Layered Catalyst

Preferably, the third catalyst comprises an ammonia oxidation catalyst (AMOx) coating in addition to the SCR coating.

### A) SCR Coating

Preferably, the SCR coating of the third catalyst is as defined in the foregoing.

Preferably, the SCR coating of the third catalyst comprises, more preferably consists of, a zeolitic material, more preferably having a framework type BEA, comprising iron and a non-zeolitic oxidic material, more preferably ceria.

The proportions of the components of the SCR coating are preferably the same as those defined in the foregoing for the third catalyst.

### B) AMOx Coating

Preferably, the AMOx coating of the third catalyst comprises a platinum group metal, more preferably one or more of Pt, Pd and Rh, more preferably one or more of Pt and Pd, more preferably Pt.

Preferably, the AMOx coating of the third catalyst comprises the platinum group metal at a loading, calculated as elemental platinum group metal, in the range of from 1 to 20 g/ft³, more preferably in the range of from 2 to 10 g/ft³, more preferably in the range of from 3 to 5 g/ft³.

Preferably, the AMOx coating of the third catalyst comprises a porous oxidic material, more preferably for supporting the platinum group metal as defined herein above, more preferably platinum.

Preferably, the porous oxidic material is selected from the group consisting of titania, alumina, ceria, silica, zirconia, a mixture of two or more thereof and a mixed oxide of two or more thereof, preferably selected from the group consisting of titania, alumina and silica, more preferably is titania.

Preferably, the AMOx coating of the third catalyst comprises the porous oxidic material in an amount in the range of from 0.25 to 3 g/in³, more preferably in the range of from 0.5 to 1.5 g/in³. Preferably, the AMOx coating of the third catalyst (further) comprises a zeolitic material comprising one or more of Fe and Cu, more preferably a zeolitic material comprising Fe.

Preferably, the zeolitic material of the AMOx coating of the third catalyst is a 12-membered ring pore zeolitic material, wherein the 12-membered ring pore zeolitic material more preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU. More preferably, the zeolitic material of the AMOx coating of the third catalyst is a zeolitic material having a framework type BEA.

Preferably from 95 to 100 weight-%, more preferably from 98 to 100 weight-%, more preferably from 99 to 100 weight-%, more preferably from 99.5 to 100 weight-%, of the framework structure of the 12-membered ring pore zeolitic material comprised in the AMOx coating of the third catalyst consist of Si, Al, and O.

Preferably, in the framework structure of the zeolitic material, the molar ratio of Si to Al, calculated as molar SiO₂:Al₂O₃, is more preferably in the range of from 2:1 to 40:1, more preferably in the range of from 3:1 to 30:1, more preferably in the range of from 4:1 to 20:1, more preferably in the range of from 6:1 to 15:1.

Preferably, the zeolitic material comprised in the AMOx coating of the third catalyst comprises iron, wherein the amount of iron comprised in the zeolitic material, calculated as Fe₂O₃, is more preferably in the range of from 0.1 to 15.0 weight-%, more preferably in the range of from 0.5 to 10.0 weight-%, more preferably in the range of from 1.5 to 7.5 weight-%, based on the total weight of the zeolitic material.

Preferably, in the AMOx coating, the weight ratio of the zeolitic material comprising one or more of Fe and Cu relative to the porous oxidic material as defined in the foregoing is in the range of from 0.5:1 to 2:1, more preferably in the range of from 0.75:1 to 1.5:1, more preferably in the range of from 1:1 to 1.25:1.

Preferably, the AMOx coating further comprises a non-zeolitic oxidic material, wherein the non-zeolitic oxidic material more preferably comprises one or more of zirconia, alumina, ceria, titania, silica, and a mixed oxide comprising two or more of Zr, Al, Ce, Ti, and Si, more preferably comprises one or more of zirconia, alumina, ceria and silica, more preferably silica.

Preferably, the AMOx coating of the third catalyst comprises the non-zeolitic oxidic material in an amount, calculated as the oxide, in the range of from 0.5 to 18 weight-%, more preferably in the range of from 5 to 16 weight-%, more preferably in the range of from 8 to 13 weight-%, based on the weight of the coating of the third catalyst.

Preferably, the AMOx coating of the third catalyst comprises a platinum group metal as defined in the foregoing, a porous oxidic material supporting the platinum group metal as defined in the foregoing, a zeolitic material comprising one or more of Fe and Cu as defined in any one of the foregoing, and preferably a non-zeolitic oxidic material as defined in the foregoing.

Preferably from 98 to 100 weight-%, more preferably from 99 to 100 weight-%, more preferably from 99.5 to 100 weight-%, more preferably from 99.9 to 100 weight-%, of the AMOx coating of the third catalyst consist of a platinum group metal as defined in the foregoing, a porous oxidic material supporting the platinum group metal as defined in the foregoing, a zeolitic material comprising one or more of Fe and Cu as defined in any one of the foregoing, and preferably a non-zeolitic oxidic material as defined in the foregoing. More preferably, the AMOx coating of the third catalyst consists of a platinum group metal as defined in the foregoing, a porous oxidic material supporting the platinum group metal as defined in the foregoing, a zeolitic material comprising one or more of Fe and Cu as defined in any one of the foregoing, and preferably a non-zeolitic oxidic material as defined in the foregoing.

Preferably the AMOx coating is disposed on the substrate of the third catalyst over 98 to 100 %, preferably 99 to 100%, more preferably 99.5 to 100%, of the substrate axial length, and the SCR coating is disposed on the AMOx coating over 98 to 100 %, preferably 99 to 100%, more preferably 99.5 to 100%, of the substrate axial length.

### Third Catalyst: SCR/AMOx Zoned Catalyst

Preferably, the third catalyst comprises an inlet zone comprising, more preferably consisting of, the SCR coating and an outlet zone comprising, more preferably consisting of, an ammonia oxidation catalyst coating.

Preferably, the inlet zone extends over x % of the substrate axial length from the inlet end to-wards the outlet end of the substrate, with x is in the range of from 20 to 60, more preferably in the range of from 30 to 55, more preferably in the range of from 45 to 55.

Preferably, the outlet zone extends over y % of the substrate axial length, with y=100−x, from the outlet end towards the inlet end of the substrate.

Preferably, the SCR coating is disposed on the substrate of the third catalyst over 50% of the substrate axial length, forming the inlet zone. Preferably, the AMOx coating is disposed on the substrate of the third catalyst over 50% of the substrate axial length.

### A) Inlet Zone: SCR Coating

Preferably, the SCR coating of the inlet zone comprises, more preferably consists of, a zeolitic material, more preferably having a framework type BEA, comprising iron and a non-zeolitic oxidic material, more preferably the non-zeolitic material being a mixture of silica and alumina.

The components and proportions of the SCR coating are preferably as defined in the foregoing.

### B) Outlet Zone: AMOx Coating

Preferably, the AMOx Coating of the Outlet Zone Comprises:
a first coat, the first coat comprising a platinum group metal supported on a porous oxidic material and a zeolitic material comprising one or more of Fe and Cu;
a second coat, the second coat comprising a zeolitic material comprising one or more of Fe and Cu, wherein at most 0.0001 weight-% of said first coat consist of platinum group metal;
wherein the first coat is disposed on the substrate over the length of the outlet zone and the second coat is disposed on the first coat over the length of the outlet zone; or wherein the second coat is disposed on the substrate over the length of the outlet zone and the first coat is disposed on the second coat over the length of the outlet zone.

Preferably the first coat is disposed on the substrate over the length of the outlet zone and the second coat is disposed on the first coat over the length of the outlet zone.

Preferably, the zeolitic material of the second coat of the AMOx coating of the third catalyst is a 12-membered ring pore zeolitic material, wherein the 12-membered ring pore zeolitic material more preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the AMOx coating of the third catalyst has a framework type BEA.

Preferably from 95 to 100 weight-%, more preferably from 98 to 100 weight-%, more preferably from 99 to 100 weight-%, more preferably from 99.5 to 100 weight-%, of the framework structure of the 12-membered ring pore zeolitic material comprised in the second coat of the AMOx coating of the third catalyst consist of Si, Al, and O.

Preferably, in the framework structure of the zeoltic material, the molar ratio of Si to Al, calculated as molar SiO₂:Al₂O₃, is more preferably in the range of from 2:1 to 40:1, more preferably in the range of from 3:1 to 30:1, more preferably in the range of from 4:1 to 20:1, more preferably in the range of from 6:1 to 15:1.

Preferably, the zeolitic material comprised in the second coat of the AMOx coating of the third catalyst comprises iron, wherein the amount of iron comprised in the zeolitic material, calculated as Fe₂O₃, is more preferably in the range of from 0.1 to 15.0 weight-%, more preferably in the range of from 1.0 to 10.0 weight-%, more preferably in the range of from 3.0 to 7.5 weight-%, based on the total weight of the zeolitic material.

Preferably, at most 0.00001 weight-% of the second coat of the AMOx coating of the third catalyst consist of a platinum metal component, wherein more preferably from 0 to 0.00001 weight-% of the second coat of the AMOx coating of the third catalyst consist of platinum group metal component.

In other words, it is preferred that the second coat of the AMOx coating of the third catalyst is substantially free, more preferably free of platinum group metal.

Preferably, the second coat of the AMOx coating of the third catalyst further comprises a non-zeolitic oxidic material, wherein the non-zeolitic oxidic material more preferably comprises one or more of zirconia, alumina, ceria, titania, silica, and a mixed oxide comprising two or more of Zr, Al, Ce, Ti, and Si, more preferably comprises one or more of zirconia, alumina, ceria and silica, more preferably ceria.

Preferably, the second coat of the AMOx coating of the third catalyst comprises the non-zeolitic oxidic material, more preferably ceria, in an amount, calculated as the oxide, in the range of from 0.5 to 12 weight-%, more preferably in the range of from 1 to 10 weight-%, more preferably in the range of from 1 to 6 weight-%, more preferably in the range of from 1 to 4 weight-%, based on the weight of the second coat of the AMOx coating of the third catalyst.

Preferably, the second coat of the AMOx coating of the third catalyst comprises a zeolitic material comprising one or more of Fe and Cu and more preferably a non-zeolitic oxidic material as defined in the foregoing.

Preferably from 98 to 100 weight-%, preferably from 99 to 100 weight-%, more preferably from 99.5 to 100 weight-%, more preferably from 99.9 to 100 weight-%, of the second coat of the AMOx coating of the third catalyst consist of a zeolitic material comprising one or more of Fe and Cu and more preferably a non-zeolitic oxidic material as defined in the foregoing. More preferably, the second coat of the AMOx coating of the third catalyst consists of a zeolitic material comprising one or more of Fe and Cu and more preferably a non-zeolitic oxidic material as defined in the foregoing.

Preferably, the platinum group metal comprised in the first coat of the AMOx coating of the third catalyst is one or more of Pt, Pd and Rh, more preferably one or more of Pt and Pd, more preferably Pt.

Preferably, the first coat of the AMOx coating of the third catalyst comprises the platinum group metal at a loading, calculated as elemental platinum group metal, in the range of from 1 to 20 g/ft³, more preferably in the range of from 2 to 10 g/ft³, more preferably in the range of from 3 to 7.5 g/ft³.

Preferably, the porous oxidic material of the first coat of the AMOx coating of the third catalyst is selected from the group consisting of titania, alumina, ceria, silica, zirconia, a mixture of two or more thereof and a mixed oxide of two or more thereof, more preferably selected from the group consisting of titania, silica and alumina, more preferably is titania.

Preferably, the first coat of the AMOx coating of the third catalyst comprises the porous oxidic material in an amount in the range of from 10 to 80 weight-%, more preferably in the range of from 30 to 70 weight-%, more preferably in the range of from 45 to 55 weight-% based on the weight of the first coat of the AMOx coating of the third catalyst.

Preferably, the zeolitic material of the first coat of the AMOx coating of the third catalyst is a 12-membered ring pore zeolitic material, wherein the 12-membered ring pore zeolitic material more preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the second coat of the AMOx coating of the third catalyst has a framework type BEA.

Preferably from 95 to 100 weight-%, more preferably from 98 to 100 weight-%, more preferably from 99 to 100 weight-%, more preferably from 99.5 to 100 weight-%, of the framework structure of the 12-membered ring pore zeolitic material comprised in the first coat of the AMOx coating of the third catalyst consist of Si, Al, and O.

Preferably, in the framework structure of the zeolitic material of the first coat, the molar ratio of Si to Al, calculated as molar SiO₂:Al₂O₃, is more preferably in the range of 2:1 to 40:1, more preferably in the range of from 3:1 to 30:1, more preferably in the range of from 4:1 to 20:1, more preferably in the range of from 6:1 to 15:1.

Preferably, the zeolitic material comprised in the first coat of the AMOx coating of the third catalyst comprises iron, wherein the amount of iron comprised in the zeolitic material, calculated as Fe₂O₃, is more preferably in the range of from 1.0 to 15.0 weight-%, more preferably in the range of from 2.0 to 10.0 weight-%, more preferably in the range of from 3.0 to 7.5 weight-%, based on the total weight of the zeolitic material.

Preferably, in the first coat of the AMOx coating of the third catalyst, the weight ratio of the zeolitic material comprising one or more of Fe and Cu relative to the porous oxidic material is in the range of from 0.25:1 to 2:1, more preferably in the range of from 0.5:1 to 1:1.

Preferably, the first coat of the AMOx coating of the third catalyst further comprises a non-zeolitic oxidic material, wherein the non-zeolitic oxidic material more preferably comprises one or more of zirconia, alumina, ceria, titania, silica, and a mixed oxide comprising two or more of Zr, Al, Ce, Ti, and Si, more preferably comprises one or more of zirconia, alumina, ceria and titania, more preferably silica.

Preferably, the first coat of the AMOx coating of the third catalyst comprises the non-zeolitic oxidic material in an amount, calculated as the oxide, in the range of from 0.5 to 18 weight-%, more preferably in the range of from 5 to 16 weight-%, more preferably in the range of from 8 to 13 weight-%, based on the weight of the first coat of the AMOx coating of the third catalyst.

Preferably, the first coat of the AMOx coating of the third catalyst comprises a platinum group metal supported on a porous oxidic material, a zeolitic material comprising one or more of Fe and Cu, and more preferably a non-zeolitic oxidic material as defined in the foregoing.

Preferably from 98 to 100 weight-%, more preferably from 99 to 100 weight-%, more preferably from 99.5 to 100 weight-%, more preferably from 99.9 to 100 weight-%, of the first coat of the AMOx coating of the third catalyst consist of a platinum group metal supported on a porous oxidic material, a zeolitic material comprising one or more of Fe and Cu, and more preferably a non-zeolitic oxidic material as defined in the foregoing. More preferably, the first coat of the AMOx coating of the third catalyst consists of a platinum group metal supported on a porous oxidic material, a zeolitic material comprising one or more of Fe and Cu, and more preferably a non-zeolitic oxidic material as defined in the foregoing.

Preferably, the AMOx coating of the third catalyst consists of the first coat and the second coat. Preferably, the third catalyst consists of the substrate, the SCR coating and the AMOx coating.

### Third Catalyst: SCR/PGM Layered Catalyst

Preferably, the third catalyst comprises an oxidation catalyst coating in addition to the SCR coating.

### A) SCR Coating

Preferably, the SCR coating of the third catalyst is as defined in the foregoing.

Preferably, the SCR coating of the third catalyst comprises, more preferably consists of, a zeolitic material, more preferably having a framework type BEA, comprising iron and a non-zeolitic oxidic material.

Preferably, the SCR coating of the third catalyst further comprises a non-zeolitic oxidic material, wherein the non-zeolitic oxidic material more preferably comprises one or more of zirconia, alumina, ceria, titania, silica, and a mixed oxide comprising two or more of Zr, Al, Ce, Ti, and Si, more preferably comprises one or more of zirconia, alumina, ceria and silica, more preferably zirconia.

Preferably, the SCR coating of the third catalyst comprises the non-zeolitic material in an amount in the range of from 0.5 to 12 weight-%, more preferably in the range of from 1 to 10 weight-%, more preferably in the range of from 1 to 6 weight-%, more preferably in the range of from 2 to 5 weight-%.

The proportions of the components of the SCR coating are preferably the same as those defined in the foregoing for the third catalyst.

### b) Oxidation Catalyst Coating

Preferably, the oxidation catalyst coating of the third catalyst comprises a platinum group metal, more preferably one or more of Pt, Pd and Rh, more preferably one or more of Pt and Pd, more preferably Pt.

Preferably, the oxidation catalyst coating of the third catalyst comprises the platinum group metal at a loading, calculated as elemental platinum group metal, in the range of from 1 to 20 g/ft³, more preferably in the range of from 2 to 10 g/ft³, more preferably in the range of from 3 to 5 g/ft³.

Preferably, the oxidation catalyst coating of the third catalyst comprises a porous oxidic material, more preferably for supporting the platinum group metal as defined herein above, more preferably platinum.

Preferably, the porous oxidic material comprises oxygen and one or more of aluminum, titanium, cerium, silicon, and zirconium, preferably one or more of aluminum, titanium and silicon, more preferably comprises aluminum.

Preferably the porous oxidic material, more preferably comprising oxygen and aluminum, further comprises a rare earth metal, more preferably one or more of lanthanum, yttrium, cerium, praesodynium, neodymium, more preferably lanthanum.

Preferably, from 1 to 6 weight-%, more preferably from 2 to 5 weight-%, of the porous material consists of the rare earth metal, calculated as the oxide.

Preferably from 99 to 100 weight-%, more preferably from 99.5 to 100 weight-%, more preferably from 99.9 to 100 weight-%, of the porous material consist of oxygen, aluminum and a rare earth metal, preferably lanthanum.

Preferably, the oxidation catalyst coating of the third catalyst comprises the porous oxidic material in an amount in the range of from 0.25 to 3 g/in³, more preferably in the range of from 0.75 to 2 g/in³.

Preferably from 98 to 100 weight-%, more preferably from 99 to 100 weight-%, more preferably from 99.5 to 100 weight-%, more preferably from 99.9 to 100 weight-%, of the oxidation catalyst coating of the third catalyst consist of a platinum group metal as defined in the foregoing and a porous oxidic material supporting the platinum group metal as defined in the foregoing. More preferably, the oxidation catalyst coating of the third catalyst consists of a platinum group metal as defined in the foregoing and a porous oxidic material supporting the platinum group metal as defined in the foregoing.

Preferably the oxidation catalyst coating is disposed on the substrate of the third catalyst over 98 to 100 %, preferably 99 to 100%, more preferably 99.5 to 100%, of the substrate axial length, and the SCR coating is disposed on the oxidation catalyst coating over 98 to 100 %, preferably 99 to 100%, more preferably 99.5 to 100%, of the substrate axial length.

Preferably, at most 0.01 weight-%, more preferably at most 0.001 weight-% of the oxidation catalyst coating of the third catalyst consist of zeolitic material, wherein more preferably from 0 to 0.0001 weight-% of the oxidation catalyst coating of the third catalyst consist of zeolitic material. In other words, it is preferred that the second coat of the AMOx coating of the third catalyst is substantially free, more preferably free of platinum group metal.

Preferably, the third catalyst consists of the substrate, the SCR coating and the oxidation catalyst coating.

Preferably, there is no catalyst between the second catalyst according to (ii) and the third catalyst according to (iii).

The present invention further relates to a method for the simultaneous selective catalytic reduction of NOx, the oxidation of a hydrocarbon, the oxidation of nitrogen monoxide and the oxidation of ammonia, comprising
(1) providing an exhaust gas stream from a gasoline engine comprising one or more of NOx, ammonia, nitrogen monoxide and a hydrocarbon;
(2) passing the exhaust gas stream provided in (1) through the exhaust gas system according to the present invention.

The present invention is further illustrated by the following set of embodiments and combinations of embodiments resulting from the dependencies and back-references as indicated. In particular, it is noted that in each instance where a range of embodiments is mentioned, for example in the context of a term such as “The system of any one of embodiments 1 to 4”, every embodiment in this range is meant to be explicitly disclosed for the skilled person, i.e. the wording of this term is to be understood by the skilled person as being synonymous to “The system of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.

1. An exhaust gas treatment system for treating an exhaust gas stream exiting a gasoline engine, said exhaust gas treatment system having an upstream end for introducing said exhaust gas stream into said exhaust gas treatment system, wherein said exhaust gas treatment system comprises
(i) a first catalyst, being a three-way conversion catalyst, having an inlet end and an outlet end and comprising a coating disposed on a substrate, wherein the coating comprises a platinum group metal component supported on a porous oxidic material;
(ii) a second catalyst, being a four-way conversion catalyst, having an inlet end and an outlet end and comprising a coating disposed on a wall flow filter substrate, wherein the coating comprises a platinum group metal component supported on a porous oxidic material;
(iii) a third catalyst having an inlet end and an outlet end, wherein the third catalyst comprises a substrate and a coating for the selective catalytic reduction of NOx, wherein the SCR coating comprises a zeolitic material comprising one or more of Fe and Cu,
wherein at most 0.0001 weight-% of said SCR coating consist of platinum group metal;
wherein the first catalyst according to (i) is the first catalyst of the exhaust gas treatment system downstream of the upstream end of the exhaust gas treatment system and
wherein the inlet end of the first catalyst is arranged upstream of the outlet end of the first catalyst;
wherein in the exhaust gas treatment system, the second catalyst according to (ii) is located downstream of the first catalyst according to (i) and wherein the inlet end of the second catalyst is arranged upstream of the outlet end of the second catalyst;
wherein in the exhaust gas treatment system, the third catalyst according to (iii) is located downstream of the second catalyst according to (ii) and wherein the inlet end of the third catalyst is arranged upstream of the outlet end of the third catalyst.

2. The exhaust gas treatment system of embodiment 1, wherein the outlet end of the first catalyst according to (i) is in fluid communication with the inlet end of the second catalyst according to (ii) and wherein between the outlet end of the first catalyst according to (i) and the inlet end of the second catalyst according to (ii), no catalyst for treating the exhaust gas stream exiting the first catalyst is located in the exhaust gas treatment system.

3. The exhaust gas treatment system of embodiment 1 or 2, wherein the outlet end of the second catalyst according to (ii) is in fluid communication with the inlet end of the third catalyst according to (iii) and wherein between the outlet end of the second catalyst according to (ii) and the inlet end of the third catalyst according to (iii), no catalyst for treating the exhaust gas stream exiting the second catalyst is located in the exhaust gas treatment system.

4. The exhaust gas treatment system of any one of embodiments 1 to 3, wherein the platinum group metal component of the coating of the first catalyst comprises one or more of Pd, Rh and Pt, preferably one or more of Pd and Rh, more preferably Pd and Rh.

5. The exhaust gas treatment system of any one of embodiments 1 to 4, wherein the coating of the first catalyst comprises the platinum group metal component at a loading, calculated as elemental platinum group metal, in the range of from 1 to 200 g/ft³, preferably in the range of from 20 to 180 g/ft³, more preferably in the range of from 50 to 150 g/ft³.

6. The exhaust gas treatment system of any one of embodiments 1 to 5, wherein the porous oxidic material supporting the platinum group metal component of the coating of the first catalyst is selected from the group consisting of alumina, ceria, silica, zirconia, titania, a mixture of two or more thereof and a mixed oxide of two or more thereof, preferably selected from the group consisting of alumina, titania, zirconia, a mixture of two or more thereof and a mixed oxide of two or more thereof, more preferably selected from the group consisting of alumina, zirconia, a mixture of two thereof, and a mixed oxide of two thereof, more preferably alumina.

7. The exhaust gas treatment system of any one of embodiments 1 to 6, wherein the coating of the first catalyst further comprises an oxygen storage component, the oxygen storage component preferably comprises cerium, more preferably comprises one or more of a cerium oxide, a mixture of oxides comprising a cerium oxide and a mixed oxide comprising cerium, wherein the mixed oxide comprising cerium more preferably additionally comprises one or more of zirconium, yttrium, neodymium, lanthanum, hafnium, samarium and praseodymium, more preferably one or more of zirconium, yttrium, neodymium, lanthanum, and praseodymium, more preferably zirconium.

8. The exhaust gas treatment system of embodiment 7, wherein the oxygen storage component of the coating of the first catalyst comprises a mixed oxide comprising cerium and zirconium;
wherein preferably from 95 to 100 weight-%, more preferably from 98 to 100 weight-%, more preferably from 99 to 100 weight-%, more preferably from 99.5 to 100 weight-% of said oxygen storage component consist of a mixed oxide comprising cerium and zirconium;
wherein more preferably from 10 to 60 weight-%, more preferably from 20 to 60 weight-%, more preferably from 20 to 50 weight-%, of the oxygen storage component consist of cerium, calculated as CeO₂, and more preferably from 20 to 90 weight-%, more preferably from 40 to 70 weight-%, more preferably from 50 to 70 weight-%, of the oxygen storage component consist of zirconium, calculated as ZrO₂; wherein more preferably from 0 to 20 weight-%, more preferably from 0 to 10 weight-% of the OSC consists of lanthanum and yttrium, calculated as La₂O₃ and Y₂O₃.

9. The exhaust gas treatment system of embodiment 7 or 8, wherein the coating of the first catalyst comprises the oxygen storage component at a loading in the range of from 0.3 to 5 g/in³, preferably in the range of from 0.4 to 3.5 g/in³, more preferably in the range of from 0.45 to 3.0 g/in³, more preferably in the range of from 0.5 to 2.5 g/in³.

10. The exhaust gas treatment system of any one of embodiments 1 to 9, wherein, in the coating of the first catalyst, the weight ratio of the porous oxidic material relative to the oxygen storage component as defined in any one of embodiments 7 to 9 is in the range of from 1:1 to 10:1, preferably in the range of from 1:1 to 5:1.

11. The exhaust gas treatment system of any of embodiments 1 to 10, wherein the coating of the first catalyst further comprises a non-zeolitic oxidic material, the non-zeolitic oxidic material preferably comprises one or more of zirconia, alumina, ceria, titania, silica, and a mixed oxide comprising two or more of Zr, Al, Ce, Ti, and Si, more preferably comprises one or more of zirconia, alumina, ceria and silica, more preferably comprises zirconia.

12. The exhaust gas treatment system of embodiment 11, wherein the coating of the first catalyst comprises the non-zeolitic oxidic material in an amount, calculated as the oxide, in the range of from 0.5 to 12 weight-%, preferably in the range of from 1 to 10 weight-%, more preferably in the range of from 1 to 5 weight-%, based on the weight of the coating of the first catalyst.

13. The exhaust gas treatment system of any of embodiments 1 to 12, wherein the coating of the first catalyst further comprises an oxide of an alkaline earth metal, the alkaline earth metal preferably being selected from the group consisting of barium, strontium and magnesium, more preferably being selected from the group consisting of barium and strontium, more preferably being barium.

14. The exhaust gas treatment system of embodiment 13, wherein the coating of the first catalyst comprises the oxide of the alkaline earth metal in an amount in the range of from 0.5 to 15 weight-%, preferably in the range of from 1 to 10 weight-%, more preferably in the range of from 1 to 6 weight-%, based on the weight of the coating of the first catalyst.

15. The exhaust gas treatment system of any one of embodiments 1 to 14, wherein from 98 to 100 weight-%, preferably from 99 to 100 weight-%, more preferably from 99.5 to 100weight-%, more preferably from 99.9 to 100 weight-%, of the coating of the first catalyst consist of a platinum group metal component supported on a porous oxidic material, preferably an oxygen storage component as defined in any one of embodiments 7 to 9, more preferably a non-zeolitic oxidic material as defined in embodiment 11 or 12, and more preferably an oxide of an alkaline earth metal as defined in embodiment 13 or 14.

16. The exhaust gas treatment system of any one of embodiments 1 to 15, wherein the substrate of the first catalyst is a flow through substrate, preferably a ceramic flow through substrate.

17. The exhaust gas treatment system of any one of embodiments 1 to 16, wherein the first catalyst consists of the substrate and the coating.

18. The exhaust gas treatment system of any one of embodiments 1 to 17, wherein the platinum group metal component of the coating of the second catalyst comprises one or more of Pd, Rh and Pt, preferably one or more of Pd and Rh, more preferably Pd and Rh;
wherein the coating of the second catalyst preferably comprises the platinum group metal component at a loading, calculated as elemental platinum group metal, in the range of from 1 to 100 g/ft³, more preferably in the range of from 3 to 80 g/ft³, more preferably in the range of from 4 to 50 g/ft³.

19. The exhaust gas treatment system of any one of embodiments 1 to 18, wherein the porous oxidic material supporting the platinum group metal component of the coating of the second catalyst is selected from the group consisting of alumina, ceria, silica, zirconia, titania, a mixture of two or more thereof and a mixed oxide of two or more thereof, preferably selected from the group consisting of alumina, titania, zirconia, a mixture of two or more thereof and a mixed oxide of two or more thereof, more preferably selected from the group consisting of alumina, zirconia, a mixture of two thereof, and a mixed oxide of two thereof, more preferably alumina.

20. The exhaust gas treatment system of any one of embodiments 1 to 19, wherein the coating of the second catalyst further comprises an oxygen storage component (OSC), the oxygen storage component preferably comprises cerium, more preferably comprises one or more of a cerium oxide, a mixture of oxides comprising a cerium oxide and a mixed oxide comprising cerium, wherein the mixed oxide comprising cerium more preferably addition-ally comprises one or more of zirconium, yttrium, neodymium, lanthanum, hafnium, samarium and praseodymium, more preferably one or more of zirconium, yttrium, neodymium, lanthanum, and praseodymium, more preferably zirconium;
wherein the oxygen storage component of the coating of the second catalyst preferably comprises a mixed oxide comprising cerium and zirconium; wherein more preferably from 95 to 100 weight-%, more preferably from 98 to 100 weight-%, more preferably from 99 to 100 weight-%, more preferably from 99.5 to 100 weight-% of said oxygen storage component consist of a mixed oxide comprising cerium and zirconium;
wherein more preferably from 10 to 60 weight-%, more preferably from 20 to 60 weight-%, more preferably from 20 to 50 weight-%, of the oxygen storage component consist of cerium, calculated as CeO₂, and more preferably from 20 to 90 weight-%, more preferably from 40 to 70 weight-%, more preferably from 50 to 70 weight-%, of the oxygen storage component consist of zirconium, calculated as ZrO 2; wherein more preferably from 0 to 20 weight-%, more preferably from 0 to 10 weight-% of the OSC consists of lanthanum and yttrium, calculated as La₂O₃ and Y₂O₃.

21. The exhaust gas treatment system of embodiment 19 or 20, wherein the coating of the second catalyst comprises the oxygen storage component at a loading in the range of from 1.5 to 2.5 g/in³, preferably in the range of from 1.2 to 2.2 g/in³, more preferably in the range of from 1.0 to 2.0 g/in³, more preferably in the range of from 1 to 1.75 g/in³.

22. The exhaust gas treatment system of any one of embodiments 1 to 21, wherein, in the coating of the second catalyst, the weight ratio of the porous oxidic material relative to the oxygen storage component as defined in any one of embodiments 17 to 19 is in the range of from 1:1 to 0.5:1, preferably in the range of from 1:1 to 0.25:1.

23. The exhaust gas treatment system of any of embodiments 1 to 22, wherein the coating of the second catalyst further comprises a non-zeolitic oxidic material, the non-zeolitic oxidic material preferably comprises one or more of zirconia, alumina, ceria, titania, silica, and a mixed oxide comprising two or more of Zr, Al, Ce, Ti, and Si, more preferably comprises one or more of zirconia, alumina, ceria and silica, more preferably comprises zirconia; wherein the coating of the second catalyst preferably comprises the non-zeolitic oxidic material in an amount, calculated as the oxide, in the range of from 0.5 to 12 weight-%, more preferably in the range of from 1 to 10 weight-%, more preferably in the range of from 1 to 5 weight-%, based on the weight of the coating of the first catalyst.

24. The exhaust gas treatment system of any of embodiments 1 to 23, wherein the coating of the second catalyst further comprises an oxide of an alkaline earth metal, the alkaline earth metal preferably being selected from the group consisting of barium, strontium and magnesium, more preferably being selected from the group consisting of barium and strontium, more preferably being barium;
wherein the coating of the second catalyst preferably comprises the oxide of the alkaline earth metal in an amount in the range of from 0.5 to 15 weight-%, preferably in the range of from 1 to 10 weight-%, more preferably in the range of from 1 to 6 weight-%, based on the weight of the coating of the first catalyst.

25. The exhaust gas treatment system of any one of embodiments 1 to 24, wherein from 98 to 100 weight-%, preferably from 99 to 100 weight-%, more preferably from 99.5 to 100 weight-%, more preferably from 99.9 to 100 weight-%, of the coating of the second catalyst consist of a platinum group metal component supported on a porous oxidic material, preferably an oxygen storage component as defined in any one of embodiments 20 to 22, more preferably a non-zeolitic oxidic material as defined in embodiment 23, and more preferably an oxide of an alkaline earth metal as defined in embodiment 24.

26. The exhaust gas treatment system of any one of embodiments 1 to 25, wherein the substrate of the second catalyst is a ceramic wall flow filter substrate.

27. The exhaust gas treatment system of any one of embodiments 1 to 26, wherein the second catalyst consists of the substrate and the coating.

28. The exhaust gas treatment system of any one of embodiments 1 to 27, wherein the zeolitic material comprised in the SCR coating of the third catalyst is a 12-membered ring pore zeolitic material, wherein the 12-membered ring pore zeolitic material preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the SCR coating of the third catalyst has a framework type BEA;
preferably wherein the zeolitic material comprised in the SCR coating of the third catalyst comprises Fe.

29. The exhaust gas treatment system of any one of embodiments 1 to 28, wherein from 95 to 100 weight-%, preferably from 98 to 100 weight-%, more preferably from 99 to 100 weight-%, more preferably from 99.5 to 100 weight-%, of the framework structure of the 12-membered ring pore zeolitic material comprised in the SCR coating of the third catalyst consist of Si, Al, and O, wherein in the framework structure, the molar ratio of Si to Al, calculated as molar SiO₂:Al₂O₃, is more preferably in the range of from 2:1 to 40:1, more preferably in the range of from 3:1 to 30:1, more preferably in the range of from 4:1 to 20:1, more preferably in the range of from 6:1 to 15:1.

30. The exhaust gas treatment system of any one of embodiments 1 to 29, wherein the zeolitic material comprised in the SCR coating of the third catalyst comprises iron, wherein the amount of iron comprised in the zeolitic material, calculated as Fe₂O₃, is preferably in the range of from 0.1 to 10.0 weight-%, more preferably in the range of from 0.5 to 8 weight-%, more preferably in the range of from 1.5 to 7.5 weight-%, based on the total weight of the zeolitic material.

31. The exhaust gas treatment system of any one of embodiments 1 to 26, wherein the SCR coating of the third catalyst further comprises a non-zeolitic oxidic material, wherein the non-zeolitic oxidic material preferably comprises one or more of zirconia, alumina, ceria, titania, silica, and a mixed oxide comprising two or more of Zr, Al, Ce, Ti, and Si, more preferably comprises one or more of zirconia, alumina, ceria and silica.

32. The exhaust gas treatment system of embodiment 31, wherein the SCR coating of the third catalyst comprises the non-zeolitic oxidic material in an amount, calculated as the oxide, in the range of from 0.5 to 12 weight-%, preferably in the range of from 1 to 10 weight-%, more preferably in the range of from 1 to 6 weight-%, based on the weight of the SCR coating of the third catalyst.

33. The exhaust gas treatment system of any one of embodiments 1 to 32, wherein at most 0.00001 weight-% of the SCR coating of the third catalyst consist of a platinum group metal, wherein preferably from 0 to 0.00001 weight-% of the SCR coating of the third catalyst consist of platinum group metal.

34. The exhaust gas treatment system of any one of embodiments 1 to 33, wherein the substrate of the third catalyst is a flow through substrate, preferably a ceramic flow through substrate.

35. The exhaust gas treatment system of any one of embodiments 1 to 34, wherein from 98 to 100 weight-%, preferably from 99 to 100 weight-%, more preferably from 99.5 to 100 weight-%, more preferably from 99.9 to 100 weight-%, of the SCR coating of the third catalyst consist of a zeolitic material comprising one or more of Fe and Cu, and preferably a non-zeolitic oxidic material as defined in embodiment 31 or 32.

36. The exhaust gas treatment system of any one of embodiments 1 to 35, wherein the third catalyst consists of the substrate and the SCR coating.

37. The exhaust gas treatment system of embodiment 36, wherein the SCR coating comprises, preferably consists of, a zeolitic material, preferably having a framework type BEA, comprising iron and a non-zeolitic oxidic material, preferably zirconia.

38. The exhaust gas treatment system of any one of embodiments 1 to 37, wherein the third catalyst comprises an ammonia oxidation catalyst (AMOx) coating in addition to the SCR coating.

39. The exhaust gas treatment system of embodiment 38, wherein the SCR coating of the third catalyst comprises, preferably consists of, a zeolitic material, preferably having a framework type BEA, comprising iron and a non-zeolitic oxidic material, preferably ceria.

40. The exhaust gas treatment system of embodiment 38 or 39, wherein the AMOx coating of the third catalyst comprises a platinum group metal, preferably one or more of Pt, Pd and Rh, more preferably one or more of Pt and Pd, more preferably Pt.

41. The exhaust gas treatment system of embodiment 40, wherein the AMOx coating of the third catalyst comprises the platinum group metal at a loading, calculated as elemental platinum group metal, in the range of from 1 to 20 g/ft³, preferably in the range of from 2 to 10 g/ft³, more preferably in the range of from 3 to 5 g/ft³.

42. The exhaust gas treatment system of any one of embodiments 38 to 41, wherein the AMOx coating of the third catalyst comprises a porous oxidic material, preferably for supporting the platinum group metal as defined in embodiment 40 or 41, wherein the porous oxidic material is selected from the group consisting of titania, alumina, ceria, silica, zirconia, a mixture of two or more thereof and a mixed oxide of two or more thereof, preferably selected from the group consisting of titania, alumina and silica, more preferably is titania.

43. The exhaust gas treatment system of embodiment 42, wherein the AMOx coating of the third catalyst comprises the porous oxidic material in an amount in the range of from 0.25 to 3 g/in³, preferably in the range of from 0.5 to 1.5 g/in³.

44. The exhaust gas treatment system of any one of embodiments 38 to 43, wherein the AMOx coating of the third catalyst (further) comprises a zeolitic material comprising one or more of Fe and Cu, preferably a zeolitic material comprising Fe.

45. The exhaust gas treatment system of embodiment 44, wherein the zeolitic material of the AMOx coating of the third catalyst is a 12-membered ring pore zeolitic material, wherein the 12-membered ring pore zeolitic material preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the AMOx coating of the third catalyst has a framework type BEA.

46. The exhaust gas treatment system of embodiment 45, wherein from 95 to 100 weight-%, preferably from 98 to 100 weight-%, more preferably from 99 to 100 weight-%, more preferably from 99.5 to 100 weight-%, of the framework structure of the 12-membered ring pore zeolitic material comprised in the AMOx coating of the third catalyst consist of Si, Al, and O, wherein in the framework structure, the molar ratio of Si to Al, calculated as molar SiO₂:Al₂O₃, is more preferably in the range of from 2:1 to 40:1, more preferably in the range of from 3:1 to 30:1, more preferably in the range of from 4:1 to 20:1, more preferably in the range of from 6:1 to 15:1.

47. The exhaust gas treatment system of any one of embodiments 44 to 46, wherein the zeolitic material comprised in the AMOx coating of the third catalyst comprises iron, wherein the amount of iron comprised in the zeolitic material, calculated as Fe₂O₃, is in the range of from 0.1 to 15.0 weight-%, more preferably in the range of from 0.5 to 10.0 weight-%, more preferably in the range of from 1.5 to 7.5 weight-%, based on the total weight of the zeolitic material.

48. The exhaust gas treatment system of any one of embodiments 44 to 47, wherein, in the AMOx coating, the weight ratio of the zeolitic material comprising one or more of Fe and Cu relative to the porous oxidic material as defined in embodiment 42 or 43 is in the range of from 0.5:1 to 2:1, preferably in the range of from 0.75:1 to 1.5:1, more preferably in the range of from 1:1 to 1.25:1.

49. The exhaust gas treatment system of any one of embodiments 38 to 48, wherein the AMOx coating further comprises a non-zeolitic oxidic material, wherein the non-zeolitic oxidic material preferably comprises one or more of zirconia, alumina, ceria, titania, silica, and a mixed oxide comprising two or more of Zr, Al, Ce, Ti, and Si, more preferably comprises one or more of zirconia, alumina, ceria and silica, more preferably silica.

50. The exhaust gas treatment system of embodiment 49, wherein the AMOx coating of the third catalyst comprises the non-zeolitic oxidic material in an amount, calculated as the oxide, in the range of from 0.5 to 18 weight-%, more preferably in the range of from 5 to 16 weight-%, more preferably in the range of from 8 to 13 weight-%, based on the weight of the coating of the third catalyst.

51. The exhaust gas treatment system of any one of embodiments 38 to 50, wherein from 98 to 100 weight-%, preferably from 99 to 100 weight-%, more preferably from 99.5 to 100 weight-%, more preferably from 99.9 to 100 weight-%, of the AMOx coating of the third catalyst consist of a platinum group metal as defined in embodiment 40 or 41, a porous oxidic material supporting the platinum group metal as defined in embodiment 42 or 43, a zeolitic material comprising one or more of Fe and Cu as defined in any one of embodiments 44 to 48, and preferably a non-zeolitic oxidic material as defined in embodiment 49 or 50.

52. The exhaust gas treatment system of any one of embodiments 38 to 50, wherein the AMOx coating is disposed on the substrate of the third catalyst over 98 to 100 %, preferably 99 to 100%, more preferably 99.5 to 100%, of the substrate axial length, and the SCR coating is disposed on the AMOx coating over 98 to 100 %, preferably 99 to 100%, more preferably 99.5 to 100%, of the substrate axial length.

53. The exhaust gas treatment system of any one of embodiments 1 to 35, wherein the third catalyst comprises an inlet zone comprising, preferably consisting of, the SCR coating and an outlet zone comprising, preferably consisting of, an ammonia oxidation catalyst coating.

54. The exhaust gas treatment system of embodiment 53, wherein the inlet zone extends over x % of the substrate axial length from the inlet end towards the outlet end of the substrate, with x is in the range of from 20 to 60, preferably in the range of from 30 to 55, more preferably in the range of from 45 to 55.

55. The exhaust gas treatment system of embodiment 54, wherein the outlet zone extends over y % of the substrate axial length, with y=100−x, from the outlet end towards the inlet end of the substrate.

56. The exhaust gas treatment system of any one of embodiments 53 to 55, wherein the SCR coating of the inlet zone comprises, preferably consists of, a zeolitic material, preferably having a framework type BEA, comprising iron and a non-zeolitic oxidic material, preferably silica and alumina.

57. The exhaust gas treatment system of any one of embodiments 53 to 56, wherein the AMOx coating of the outlet zone comprises:
a first coat, the first coat comprising a platinum group metal supported on a porous oxidic material and a zeolitic material comprising one or more of Fe and Cu;
a second coat, the second coat comprising a zeolitic material comprising one or more of Fe and Cu, wherein at most 0.0001 weight-% of said first coat consist of platinum group metal;
   wherein the first coat is disposed on the substrate over the length of the outlet zone and the second coat is disposed on the first coat over the length of the outlet zone; or wherein the second coat is disposed on the substrate over the length of the outlet zone and the first coat is disposed on the second coat over the length of the outlet zone.

58. The exhaust gas treatment system of embodiment 57, wherein the zeolitic material of the second coat of the AMOx coating of the third catalyst is a 12-membered ring pore zeolitic material, wherein the 12-membered ring pore zeolitic material preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the AMOx coating of the third catalyst has a framework type BEA.

59. The exhaust gas treatment system of embodiment 58, wherein from 95 to 100 weight-%, preferably from 98 to 100 weight-%, more preferably from 99 to 100 weight-%, more preferably from 99.5 to 100 weight-%, of the framework structure of the 12-membered ring pore zeolitic material comprised in the second coat of the AMOx coating of the third catalyst consist of Si, Al, and O, wherein in the framework structure, the molar ratio of Si to Al, calculated as molar SiO₂:Al₂O₃, is more preferably in the range of from 2:1 to 40:1, more preferably in the range of from 3:1 to 30:1, more preferably in the range of from 4:1 to 20:1, more preferably in the range of from 6:1 to 15:1.

60. The exhaust gas treatment system of any one of embodiments 57 to 59, wherein the zeolitic material comprised in the second coat of the AMOx coating of the third catalyst comprises iron, wherein the amount of iron comprised in the zeolitic material, calculated as Fe₂O₃, is in the range of from 0.1 to 15.0 weight-%, more preferably in the range of from 1.0 to 10.0 weight-%, more preferably in the range of from 3.0 to 7.5 weight-%, based on the total weight of the zeolitic material.

61. The exhaust gas treatment system of any one of embodiments 57 to 60, wherein at most 0.00001 weight-% of the second coat of the AMOx coating of the third catalyst consist of a platinum metal component, wherein preferably from 0 to 0.00001 weight-% of the second coat of the AMOx coating of the third catalyst consist of platinum group metal component.

62. The exhaust gas treatment system of any one of embodiments 57 to 61, wherein the second coat of the AMOx coating of the third catalyst further comprises a non-zeolitic oxidic material, wherein the non-zeolitic oxidic material preferably comprises one or more of zirconia, alumina, ceria, titania, silica, and a mixed oxide comprising two or more of Zr, Al, Ce, Ti, and Si, more preferably comprises one or more of zirconia, alumina, ceria and silica, more preferably ceria.

63. The exhaust gas treatment system of embodiment 62, wherein the second coat of the AMOx coating of the third catalyst comprises the non-zeolitic oxidic material in an amount, calculated as the oxide, in the range of from 0.5 to 12 weight-%, more preferably in the range of from 1 to 10 weight-%, more preferably in the range of from 1 to 6 weight-%, more preferably in the range of from 1 to 4 weight-%, based on the weight of the second coat of the AMOx coating of the third catalyst.

64. The exhaust gas treatment system of any one of embodiments 57 to 63, wherein from 98 to 100 weight-%, preferably from 99 to 100 weight-%, more preferably from 99.5 to 100 weight-%, more preferably from 99.9 to 100 weight-%, of the second coat of the AMOx coating of the third catalyst consist of a zeolitic material comprising one or more of Fe and Cu and preferably a non-zeolitic oxidic material as defined in embodiment 62 or 63.

65. The exhaust gas treatment system of any one of embodiments 57 to 64, wherein the platinum group metal comprised in the first coat of the AMOx coating of the third catalyst is one or more of Pt, Pd and Rh, more preferably one or more of Pt and Pd, more preferably Pt.

66. The exhaust gas treatment system of embodiment 65, wherein the first coat of the AMOx coating of the third catalyst comprises the platinum group metal at a loading, calculated as elemental platinum group metal, in the range of from 1 to 20 g/ft³, preferably in the range of from 2 to 10 g/ft³, more preferably in the range of from 3 to 7.5 g/ft³.

67. The exhaust gas treatment system of any one of embodiments 57 to 66, wherein the porous oxidic material of the first coat of the AMOx coating of the third catalyst is selected from the group consisting of titania, alumina, ceria, silica, zirconia, a mixture of two or more thereof and a mixed oxide of two or more thereof, preferably selected from the group consisting of titania, silica and alumina, more preferably is titania.

68. The exhaust gas treatment system of any one of embodiments 57 to 67, wherein the first coat of the AMOx coating of the third catalyst comprises the porous oxidic material in an amount in the range of from 10 to 80 weight-%, preferably in the range of from 30 to 70 weight-%, more preferably in the range of from 45 to 55 weight-% based on the weight of the first coat of the AMOx coating of the third catalyst.

69. The exhaust gas treatment system of any one of embodiments 57 to 68, wherein the zeolitic material of the first coat of the AMOx coating of the third catalyst is a 12-membered ring pore zeolitic material, wherein the 12-membered ring pore zeolitic material preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the second coat of the AMOx coating of the third catalyst has a framework type BEA.

70. The exhaust gas treatment system of embodiment 69, wherein from 95 to 100 weight-%, preferably from 98 to 100 weight-%, more preferably from 99 to 100 weight-%, more preferably from 99.5 to 100 weight-%, of the framework structure of the 12-membered ring pore zeolitic material comprised in the first coat of the AMOx coating of the third catalyst consist of Si, Al, and O, wherein in the framework structure, the molar ratio of Si to Al, calculated as molar SiO₂:Al₂O₃, is more preferably in the range of 2:1 to 40:1, more preferably in the range of from 3:1 to 30:1, more preferably in the range of from 4:1 to 20:1, more preferably in the range of from 6:1 to 15:1.

71. The exhaust gas treatment system of any one of embodiments 57 to 70, wherein the zeolitic material comprised in the first coat of the AMOx coating of the third catalyst comprises iron, wherein the amount of iron comprised in the zeolitic material, calculated as Fe₂O₃, is preferably in the range of from 1.0 to 15.0 weight-%, more preferably in the range of from 2.0 to 10.0 weight-%, more preferably in the range of from 3.0 to 7.5 weight-%, based on the total weight of the zeolitic material.

72. The exhaust gas treatment system of any one of embodiments 57 to 71, wherein, in the first coat of the AMOx coating of the third catalyst, the weight ratio of the zeolitic material comprising one or more of Fe and Cu relative to the porous oxidic material is in the range of from 0.25:1 to 2:1, preferably in the range of from 0.5:1 to 1:1.

73. The exhaust gas treatment system of any one of embodiments 57 to 72, wherein the first coat of the AMOx coating of the third catalyst further comprises a non-zeolitic oxidic material, wherein the non-zeolitic oxidic material preferably comprises one or more of zirconia, alumina, ceria, titania, silica, and a mixed oxide comprising two or more of Zr, Al, Ce, Ti, and Si, more preferably comprises one or more of zirconia, alumina, ceria and titania, more preferably silica.

74. The exhaust gas treatment system of embodiment 73, wherein the first coat of the AMOx coating of the third catalyst comprises the non-zeolitic oxidic material in an amount, calculated as the oxide, in the range of from 0.5 to 18 weight-%, more preferably in the range of from 5 to 16 weight-%, more preferably in the range of from 8 to 13 weight-%, based on the weight of the first coat of the AMOx coating of the third catalyst.

75. The exhaust gas treatment system of any one of embodiments 57 to 74, wherein from 98 to 100 weight-%, preferably from 99 to 100 weight-%, more preferably from 99.5 to 100 weight-%, more preferably from 99.9 to 100 weight-%, of the first coat of the AMOx coating of the third catalyst consist of a platinum group metal supported on a porous oxidic material, a zeolitic material comprising one or more of Fe and Cu, and preferably a non-zeolitic oxidic material as defined in embodiment 73 or 74.

76. The exhaust gas treatment system of any one of embodiments 57 to 75, wherein the AMOx coating of the third catalyst consists of the first coat and the second coat.

77. The exhaust gas treatment system of any one of embodiments 57 to 76, wherein the third catalyst consists of the substrate, the SCR coating and the AMOx coating.

78. The exhaust gas treatment system of any one of embodiments 1 to 37, wherein the third catalyst comprises an oxidation catalyst coating in addition to the SCR coating.

79. The exhaust gas treatment system of embodiment 78, wherein the oxidation catalyst coating of the third catalyst comprises a platinum group metal, preferably one or more of Pt, Pd and Rh, more preferably one or more of Pt and Pd, more preferably Pt.

80. The exhaust gas treatment system of embodiment 79, wherein the oxidation catalyst coating of the third catalyst comprises the platinum group metal at a loading, calculated as elemental platinum group metal, in the range of from 1 to 20 g/ft³, preferably in the range of from 2 to 10 g/ft³, more preferably in the range of from 3 to 5 g/ft³.

81. The exhaust gas treatment system of any one of embodiments 78 to 80, wherein the oxidation catalyst coating of the third catalyst comprises a porous oxidic material, preferably for supporting the platinum group metal as defined in embodiment 79 or 80, more preferably platinum.

82. The exhaust gas treatment system of embodiment 81, wherein the porous oxidic material comprises oxygen and one or more of aluminum, titanium, cerium, silicon, and zirconium, preferably one or more of aluminum, titanium and silicon, more preferably comprises aluminum.

83. The exhaust gas treatment system of embodiment 81 or 82, wherein the porous oxidic material, preferably comprising oxygen and aluminum, further comprises a rare earth metal, more preferably one or more of lanthanum, yttrium, cerium, praesodynium, neodymium, more preferably lanthanum.

84. The exhaust gas treatment system of any one of embodiments 81 to 83, wherein from 1 to 6 weight-%, preferably from 2 to 5 weight-%, of the porous material consists of the rare earth metal, calculated as the oxide.

85. The exhaust gas treatment system of any one of embodiments 81 to 84, wherein from 99 to 100 weight-%, preferably from 99.5 to 100 weight-%, more preferably from 99.9 to 100 weight-%, of the porous material consist of oxygen, aluminum and a rare earth metal, preferably lanthanum.

86. The exhaust gas treatment system of any one of embodiments 81 to 85, wherein the oxidation catalyst coating of the third catalyst comprises the porous oxidic material in an amount in the range of from 0.25 to 3 g/in³, preferably in the range of from 0.75 to 2 g/in³.

87. The exhaust gas treatment system of any one of embodiments 78 to 86, wherein from 98 to 100 weight-%, preferably from 99 to 100 weight-%, more preferably from 99.5 to 100 weight-%, more preferably from 99.9 to 100 weight-%, of the oxidation catalyst coating of the third catalyst consist of a platinum group metal as defined in embodiment 79 or 80 and a porous oxidic material supporting the platinum group metal as defined in any one of embodiments 81 to 86.

88. The exhaust gas treatment system of any one of embodiments 78 to 87, wherein the oxidation catalyst coating is disposed on the substrate of the third catalyst over 98 to 100 %, preferably 99 to 100%, more preferably 99.5 to 100%, of the substrate axial length, and the SCR coating is disposed on the oxidation catalyst coating over 98 to 100 %, preferably 99 to 100%, more preferably 99.5 to 100%, of the substrate axial length.

89. The exhaust gas treatment system of any one of embodiments 78 to 88, wherein the third catalyst consists of the substrate, the SCR coating and the oxidation catalyst coating.

90. The exhaust gas treatment system of any one of embodiments 78 to 89, wherein at most 0.01 weight-%, more preferably at most 0.001 weight-% of the oxidation catalyst coating of the third catalyst consist of zeolitic material, wherein more preferably from 0 to 0.0001 weight-% of the oxidation catalyst coating of the third catalyst consist of zeolitic material.

91. A method for the simultaneous selective catalytic reduction of NOx, the oxidation of a hydrocarbon, the oxidation of nitrogen monoxide and the oxidation of ammonia, comprising
(1) providing an exhaust gas stream from a gasoline engine comprising one or more of NOx, ammonia, nitrogen monoxide and a hydrocarbon;
(2) passing the exhaust gas stream provided in (1) through the exhaust gas system according to any one of embodiments 1 to 90.

In the context of the present invention, the term “disposed on the substrate” means that the coating is disposed on the surface of the internal walls of the substrate, wherein the term “the surface of the internal walls” is to be understood as the “naked” or “bare” or “blank” surface of the walls, i.e. the surface of the walls in an untreated state which consists—apart from any unavoidable impurities with which the surface may be contaminated-of the material of the walls.

Further, in the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A 5 and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. 10 “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

Furthermore, in the context of the present invention, the term “consists of” with regard to the weight-% of one or more components indicates the weight-% amount of said component(s) based on 100 weight-% of the entity in question. For example, the wording “wherein from 0 to 0.001 weight-% of the second coating consists of platinum” indicates that among the 100 weight-% of the components of which said coating consists of, 0 to 0.001 weight-% is platinum. Furthermore, in the context of the present invention, the term “close coupled” catalyst is used herein to define a catalyst which is the first catalyst receiving the exhaust gas stream exiting from an engine.

The present invention is further illustrated by the examples below.

### Examples

### Analytics—Measurements

### 1.1 Determination of BET Specific Surface Area of Alumina

The BET specific surface area of the alumina was determined according to DIN 66131 or DIN-ISO 9277 using liquid nitrogen.

### 1.2 Determination of the Volume-Based Particle Size Distributions Dv90

The particle size distributions were determined by a static light scattering method using a Sympatec HELOS/BR-OM & QUIXEL wet dispersion equipment, fitted with laser (HeNe) diffraction sensor with 31 channel multielement detection range comprising 5 modules covering 0.1-875 microns.

### Reference Example 1 a Three-Way Conversion (TWC) Catalyst

An aqueous mixture of palladium and rhodium salt precursors were impregnated on high porosity alumina and ceria-zirconia. The obtained mixture of Pd/Rh on alumina (100% high porosity alumina) and ceria-zirconia (solid content: 60-75 wt.-%) was calcined at 400-600° C. for 2-4 hours.

A mixture was prepared by mixing water, n-octanol and a precursor of baria and zirconia. The amount of the baria precursor was calculated such that the final loading of BaO in the catalyst after calcination was 1-10 wt.-% based on the weight of the coating and the amount of zirconia precursor was calculated such that the loading of ZrO₂, from said source, in the catalyst after calcination was 1-5 wt.-% based on the weight of the coating. The obtained calcined Pd/Rh on alumina and/or ceria-zirconia was added to the mixture comprising n-octanol obtaining a slurry. The slurry solid content was adjusted to 30-50 wt.-% to enhance pH and viscosity measurements and wet milling. After milling, the pH of the slurry was adjusted by adding nitric acid to have a pH of 3-5. The particle size distribution (Dv90) of the slurry was after milling was of 10-20 micrometers.

The obtained slurry was disposed over the entire length of a non-coated ceramic honeycomb flow through substrate (diameter: 4.66 inches×length: 2.5 inches, cylindrical shaped substrate with 750/(2.54)² cells per square centimeter and 0.0635 millimeter (2.5 mil) wall thickness), dried at 120-180° C. and further calcined at 400-600° C. in air. The final coating comprises high porosity alumina, ceria-zirconia, Pd, Rh, zirconia and baria. The loading of the coating is from 1.5 to 4 g/in³.

### Reference Example 2 a Four-Way Conversion (FWC) Catalyst

An aqueous mixture of palladium and rhodium salt precursors were impregnated on high porosity alumina and ceria-zirconia. The obtained mixture of Pd/Rh on alumina and ceria-zirconia (solid content: 50-80 wt.-%) was calcined at 400-600° C. for 2-4 hours.

A mixture was prepared by mixing water, n-octanol and a precursor of baria and zirconia. The amount of the baria precursor was calculated such that the final loading of BaO in the catalyst after calcination was 1-5 wt.-% based on the weight of the coating and the amount of zirconia precursor was calculated such that the loading of ZrO₂, from said source, in the catalyst after calcination was 1-5 wt.-% based on the weight of the coating. The obtained calcined Pd/Rh on alumina and/or ceria-zirconia was added to the mixture comprising n-octanol obtaining a slurry. The slurry solid content was adjusted to 30-50 wt.-% to enhance pH and viscosity measurements and wet milling. After milling, the pH of the slurry was adjusted by adding nitric acid to have a pH of 3-5. The particle size distribution (Dv90) of the slurry was after milling was of 7-18 micrometers.

The obtained slurry was disposed over the entire length of a non-coated ceramic honeycomb wall flow substrate (diameter: 4.66 inches×length: 4.26 inches, cylindrical shaped substrate with 300/(2.54)² cells per square centimeter and 0.2 millimeter (8 mil) wall thickness), dried at 120-180° C. and further calcined at 400-600° C. in air. The final coating comprises high porosity alumina, ceria-zirconia, Pd, Rh, zirconia and baria. The loading of the coating is from 1 to 3 g/in³.

### Comparative Example 1 an Exhaust Gas Treatment System Not According to the Present Invention

The exhaust gas treatment system of Comparative Example 1 comprises the catalyst of Reference Example 1 (TWC catalyst) as Catalyst 1, the catalyst of Reference 2 (FWC catalyst) as Catalyst 2 and the catalyst of Reference Example 1 (TWC catalyst) as Catalyst 3, wherein Catalyst 1 is located upstream of Catalyst 2 and Catalyst 2 is located upstream of Catalyst 3. No catalyst are present between Catalyst 1 and 2 and Catalyst 2 and 3 and Catalyst 1 is a close coupled catalyst. The system is illustrated in FIG. 1.

### Reference Example 3 an Ammonia Oxidation (AMOx) Catalyst

### PGM-Containing Bottom Coating

An aqueous mixture of a Pt precursor was impregnated on high surface area and porous oxidic supports like alumina, titania, ceria-zirconia or mixtures of these in an aqueous medium. The obtained mixture had a solid content of 50-70%. Said slurry was wet milled such as to obtain a Dv90 of 10-25 micrometers. Further, separately, appropriate amounts of Fe-BEA (Fe content, calculated as Fe₂O₃: 1.5 to 7.5 weight-% based on the weight of the zeolite, a silica to alumina molar ratio of from 6-15:1) and silica (8-13 weight-%, calculated as SiO₂, based on the weight of the PGM-containing coating) were mixed in distilled water obtaining a mixture with a solid content of 30-50%. The BEA-containing mixture and the Pt-containing mixture were mixed and wet-milled such as to obtain a particle size distribution Dv90 of 2-15 micrometers. The obtained slurry was then disposed over the entire length of a non-coated ceramic honeycomb flow through substrate (diameter: 5.66 inches×length: 3 inches, cylindrical shaped substrate with 400/(2.54)² cells per square centimeter and 0.1 millimeter (4 mil) wall thickness), dried at 120-180° C. and calcined at 400-600° C. in air. The loading of the PGM coating was 1-3 g/in³.

### PGM-Free Top Coating

A mixture of a precursor of ceria (1-4 weight-%, calculated as CeO₂, based on the weight of the PGM-free coating) and distilled water was prepared and a Fe-BEA zeolite (Fe content, calculated as Fe₂O₃: 1.5 to 7.5 weight-% based on the weight of the zeolite, a silica to alumina molar ratio of 6-15:1) was added to said mixture under constant mixing. The solid content of the obtained slurry was 20-40%. The slurry was dispersed and mixed such as to obtain a Dv90 of 2 -12 micrometers. The obtained slurry was then disposed over the entire length of the substrate coated with the PGM-containing bottom coating, dried at 120-180° C. and calcined at 400-600° C. in air. The loading of the PGM-free coating was 1-3 g/in³.

### Reference Example 4 A Selective Catalytic Reduction (SCR)/AMOx Catalyst

### SCR Coating

A mixture of distilled water and Fe-BEA zeolite (Fe content, calculated as Fe₂O₃: 1.5 to 7.5 weight-% based on the weight of the zeolite, a silica to alumina molar ratio of from 6-15:1) was prepared, wherein silica and alumina powders as minor additives were added. The amount of the additives was calculated such that the amount of silica+alumina in the SCR coating was of 1-5 wt. %, calculated as the oxides (SiO₂, Al₂O₃), based on the weight of the SCR coating. The solid content of the obtained mixture was 30-50%. The slurry was wet milled such as to obtain a Dv90 of 3-18 micrometers.

The obtained slurry was disposed over 50% of the entire length of a non-coated ceramic honeycomb flow through substrate from the inlet end of the substrate towards the outlet end of the substrate (diameter: 5.66 inches×length: 3 inches, cylindrical shaped substrate with 400/(2.54)² cells per square centimeter and 0.1 millimeter (4 mil) wall thickness), dried at 120-180° C. and further calcined at 400-600° C. in air. The SCR coating comprises Fe-BEA zeolite, alumina and silica. The loading of the SCR coating was 2-4 g/in³.

### AMOx Coating

PGM-containing bottom coat: prepared as in Reference Example 3

PGM-free top coat: prepared as in Reference Example 3

The obtained slurry for the PGM bottom coat was disposed over 50% of the entire length of the ceramic honeycomb flow through substrate coated with the SCR coating from the outlet end of the substrate towards the inlet end of the substrate and the obtained slurry for the PGM-free top coat was disposed over 50% of the entire length of the ceramic honeycomb flow through substrate coated on top of the PGM bottom coating. The loading of the AMOx coating was 2.5-4 g/in³.

### Reference Example 5 A Selective Catalytic Reduction (SCR) Catalyst

A mixture of distilled water and Fe-BEA zeolite (Fe content, calculated as Fe₂O₃: 1.5 to 7.5 weight-% based on the weight of the zeolite) was prepared, wherein zirconia precursor as an additive was added. The amount of zirconia precursor was calculated such that the amount of zirconia in the catalyst was of 1-5 wt. % based on the weight of the coating. The solid content of the obtained mixture was 30-45%. The slurry was milled such as to obtain a Dv90 of 3-12 micrometers.

The obtained slurry was disposed over the entire length of a non-coated ceramic honeycomb flow through substrate (diameter: 4.66 inches×length: 3 inches, cylindrical shaped substrate with 400/(2.54)² cells per square centimeter and 0.08 millimeter (3 mil) wall thickness), dried at 120-180° C. and further calcined at 400-600° C. in air. The SCR coating comprises Fe-BEA zeolite and zirconia. The loading of the SCR coating was 2-4 g/in³.

### Reference Example 6 An Ammonia Oxidation (AMOx) Catalyst

### PGM-Containing Bottom Coating

An aqueous mixture of a Pt precursor was impregnated on high surface area and porous oxidic supports like alumina, preferably La-doped alumina (4 weight-% of La, calculated as La₂O₃, based on the weight of said support) in an aqueous medium. The obtained mixture had a solid content of 50-70%. Said slurry was wet milled such as to obtain a Dv90 of 2-25 micrometers. The obtained slurry was then disposed over the entire length of a non-coated ceramic honeycomb flow through substrate (diameter: 5.66 inches×length: 3 inches, cylindrical shaped substrate with 400/(2.54)² cells per square centimeter and 0.1 millimeter (4 mil) wall thickness), dried at 120-180° C. and calcined at 400-600° C. in air. The loading of the PGM coating was 1-2 g/in³.

### PGM-Free Top Coating

A mixture of a precursor of zirconia (2-5 weight-%, calculated as ZrO₂, based on the weight of the PGM-free coating) and distilled water was prepared and a Fe-BEA zeolite (Fe content, calculated as Fe₂O₃: 1.5 to 7.5 weight-% based on the weight of the zeolite, a silica to alumina molar ratio of 6-15:1) was added to said mixture under constant mixing. The solid content of the obtained slurry was 20-40%. The slurry was dispersed and mixed such as to obtain a Dv90 of 2 -12 micrometers. The obtained slurry was then disposed over the entire length of the substrate coated with the PGM-containing bottom coating, dried at 120-180° C. and calcined at 400-600° C. in air. The loading of the PGM-free coating was 1.5-3 g/in³.

### Reference Example 7 A Selective Catalytic Reduction (SCR) Catalyst

A mixture of distilled water and Cu-CHA zeolite (Cu content, calculated as CuO: 3.4 weight-% based on the weight of the zeolite) was prepared, wherein zirconia precursor as an additive was added. The amount of zirconia precursor was calculated such that the amount of zirconia in the catalyst was of 1-5 wt. % based on the weight of the coating. The solid content of the obtained mixture was 42%. The slurry was milled such as to obtain a Dv90 of 3-12 micrometers.

The obtained slurry was disposed over the entire length of a non-coated ceramic honeycomb flow through substrate (diameter: 4.66 inches×length: 3 inches, cylindrical shaped substrate with 400/(2.54)² cells per square inch and 0.08 millimeter (3 mil) wall thickness), dried at 120-180° C. and further calcined at 400-600° C. in air. The SCR coating comprises Cu-CHA zeolite and zirconia. The loading of the SCR coating was 2 g/in³.

### Comparative Example 2 an Exhaust Gas Treatment System Not According to the Present Invention

The exhaust gas treatment system of Comparative Example 2 comprises the catalyst of Reference Example 1 (TWC catalyst) as Catalyst 1, the catalyst of Reference 2 (FWC catalyst) as Catalyst 2 and the catalyst of Reference Example 7 (SCR catalyst) as Catalyst 3, wherein Catalyst 1 is located upstream of Catalyst 2 and Catalyst 2 is located upstream of Catalyst 3. No catalyst are present between Catalyst 1 and 2 and Catalyst 2 and 3 and Catalyst 1 is a close coupled catalyst.

### Example 1 an Exhaust Gas Treatment System According to the Present Invention

The exhaust gas treatment system of Example 1 comprises the catalyst of Reference Example 1 (TWC catalyst) as Catalyst 1, the catalyst of Reference Example 2 (FWC catalyst) as Catalyst 2 and the catalyst of Reference Example 3 (AMOx catalyst) as Catalyst 3, wherein Catalyst 1 is located upstream of Catalyst 2 and Catalyst 2 is located upstream of Catalyst 3. No catalyst are present between Catalysts 1 and 2 and Catalysts 2 and 3. Catalyst 1 is a close coupled catalyst. The system is illustrated in FIG. 1.

### Example 2 An Exhaust Gas Treatment System According to the Present Invention

The exhaust gas treatment system of Example 2 comprises the catalyst of Reference Example 1 (TWC catalyst) as Catalyst 1, the catalyst of Reference Example 2 (FWC catalyst) as Catalyst 2 and the catalyst of Reference Example 4 (SCR/AMOx catalyst) as Catalyst 3, wherein Catalyst 1 is located upstream of Catalyst 2, Catalyst 2 is located upstream of Catalyst 3. No catalyst are present between Catalysts 1 and 2 and Catalysts 2 and 3. Catalyst 1 is a close coupled catalyst. The system is illustrated in FIG. 1.

### Example 3 an Exhaust Gas Treatment System According to the Present Invention

The exhaust gas treatment system of Example 3 comprises the catalyst of Reference Example 1 (TWC catalyst) as Catalyst 1, the catalyst of Reference Example 2 (FWC catalyst) as Catalyst 2 and the catalyst of Reference Example 5 (SCR catalyst) as Catalyst 3, wherein Catalyst 1 is located upstream of Catalyst 2 and Catalyst 2 is located upstream of Catalyst 3. No catalyst are present between Catalysts 1 and 2 and Catalysts 2 and 3. Catalyst 1 is a close coupled catalyst. The system is illustrated in FIG. 1.

### Example 4 HC and NH₃ Tailpipe Emissions Under WLTC—Testing of the Systems According to Examples 1-3 and Comparative Example 1

In the different systems, Catalyst 1 (TWC) and Catalyst 2 (FWC) are located in the same can in combination with a different downstream component in Comparative Example 1 and Examples 1-3. The comparative system comprising the TWC and FWC with a TWC downstream represents a standard Euro 6 configuration, while the inventive systems composed of either an AMOx, an SCR or a combination of both in the underfloor position downstream of the TWC+FWC is representative of a Euro 7 gasoline application.

The systems evaluated were aged on an engine bench using a 2L Euro 6 engine, such that the canning containing a TWC+FWC was placed in the CC position, while the component (TWC, AMOx, SCR+AMOx or SCR) under evaluation was placed downstream in a separate can. For all systems studied, the same CC unit was used upstream. The aging is lambda 1 type with periodic fuel-cut or lean/rich perturbations with downstream catalyst inlet temperatures of 830° C. Aging duration was 20 h. Thermocouples placed in different positions along the exhaust line could record engine out, catalyst inlet and bed temperatures.

The system and consequently component evaluation (WLTC) was carried out on a Euro 6 GTDI vehicle using a chassis dyno test cell. The latter is fitted with thermo-elements and FT-IR units at the engine out/catalyst inlet, catalyst bed and outlet positions, allowing for accurate recording of temperatures and gaseous emissions along the exhaust line.

Data presented contains the cumulated HC and NH₃ (FIGS. 2-3) emissions for each systems (FIG. 1) using the WLTC cycle collected on the vehicle described above.

As may be taken from FIG. 2, the cumulated HC emissions obtained with the comparative system are significantly higher compared to those of the inventive systems particularly at low speed and temperatures up to 200 seconds in the WLTC cycle. The best results being obtained with an SCR-only downstream configuration, which contains the highest Fe-BEA loading, an indication that the superior low temperature HC tailpipe reduction is directly related to the zeolite loading. Thus, with the system according to the present invention, the overall HC emissions are greatly reduced under evaluation conditions in the WLTC cycle. Finally, as may be taken from FIG. 3, the cumulated NH₃ much emissions are significantly higher for comparative system compared to the new inventive systems according to the present invention. The best results are obtained with the AMOx downstream system, while the highest emissions are created over the SCR-only underfloor system.

Therefore, it has been demonstrated that the system according to the present invention which comprises an AMOx catalyst, or a SCR catalyst or both downstream of a TWC+FWC CC1 configuration permits to improve the HC and NOx conversions. Without wanting to be bound top any theory, it is believed that the PGM-free zeolite coating in the downstream position plays a key role in the process.

### Example 5 An Exhaust Gas Treatment System According to the Present Invention

The exhaust gas treatment system of Example 1 comprises the catalyst of Reference Example 1 (TWC catalyst) as Catalyst 1, the catalyst of Reference Example 2 (FWC catalyst) as Catalyst 2 and the catalyst of Reference Example 6 (AMOx catalyst) as Catalyst 3, wherein Catalyst 1 is located upstream of Catalyst 2 and Catalyst 2 is located upstream of Catalyst 3. No catalyst are present between Catalysts 1 and 2 and Catalysts 2 and 3. Catalyst 1 is a close coupled catalyst.

### Example 6 HC and NH₃ Tailpipe Emissions Under WLTC—Testing of the Systems According to Example 3 and Comparative Example 2

In the different systems, Catalyst 1 (TWC) and Catalyst 2 (FWC) are located in the same can in combination with a different downstream component in Comparative Example 2 and Example 3. The comparative system comprising a Cu-CHA SCR catalyst and the inventive Example 3 comprising a Fe-BEA SCR catalyst.

The systems evaluated were aged on an engine bench using a 2L Euro 6 engine, such that the canning containing a TWC+FWC was placed in the CC position, while the SCR component under evaluation was placed downstream in a separate can. For all systems studied, the same CC unit was used upstream. The aging is lambda 1 type with periodic fuel-cut or lean/rich perturbations with downstream catalyst inlet temperatures of 820° C. Aging duration was 80 h. Thermocouples placed in different positions along the exhaust line could record engine out, catalyst inlet and bed temperatures.

The system and consequently component evaluation (WLTC) was carried out on a Euro 6 GTDI vehicle using a chassis dyno test cell. The latter is fitted with thermo-elements and FT-IR units at the engine out/catalyst inlet, catalyst bed and outlet positions, allowing for accurate recording of temperatures and gaseous emissions along the exhaust line.

Data presented contains the cumulated NH₃, CO and N₂O (FIGS. 4-6) emissions for each systems (FIG. 1) using the WLTC cycle collected on the vehicle described above. As may be taken from FIGS. 4 to 6, the cumulated NH₃, CO and N₂O emissions are significantly higher for Comparative Example 2 compared to inventive Example 3.

Therefore, it has been demonstrated that the system according to the present invention which comprises an Fe-BEA SCR catalyst downstream of a TWC+FWC CC1 configuration permits to improve the NH₃, CO and N₂O conversions.

### DESCRIPTION OF THE FIGURE(S)

FIG. 1 shows a schematic of exhaust gas treatment systems according to Comparative Example 1 and Examples 1 to 3.

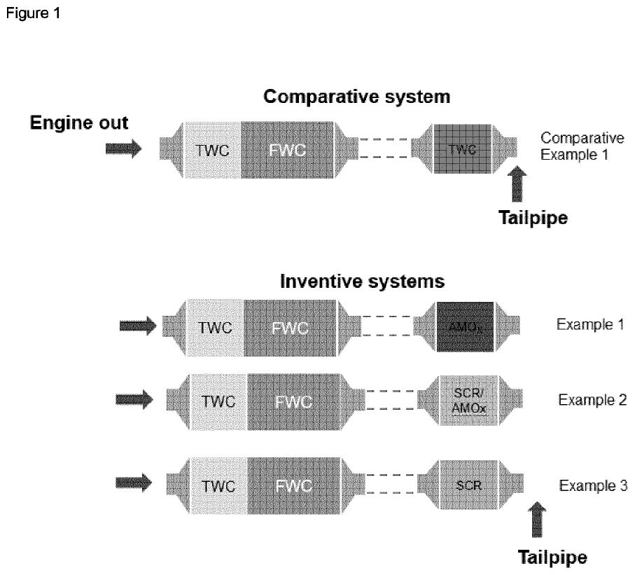

FIG. 2 shows the HC cumulated obtained with the systems of Examples 1-3 and Comparative Example 1 after aging.

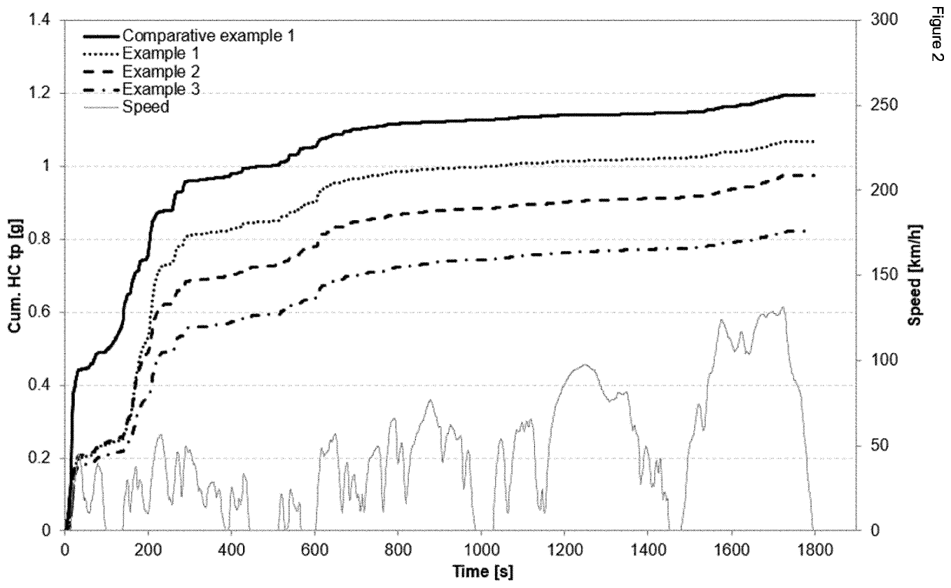

FIG. 3 shows the NH₃ cumulated obtained with the systems of Examples 1-3 and Comparative Example 1 after aging.

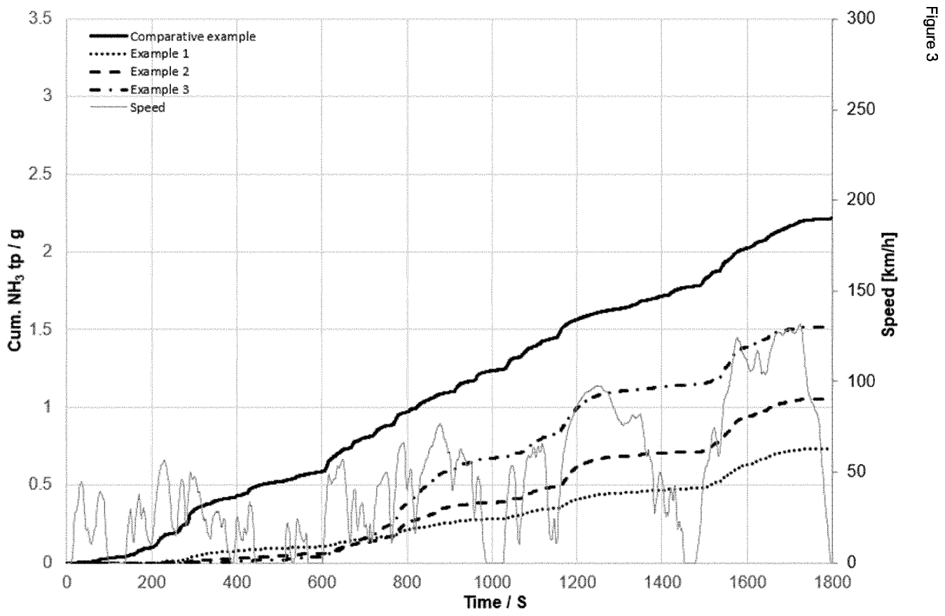

FIG. 4 shows the NH₃ cumulated obtained with the systems of Example 3 and Comparative Example 2 after aging.

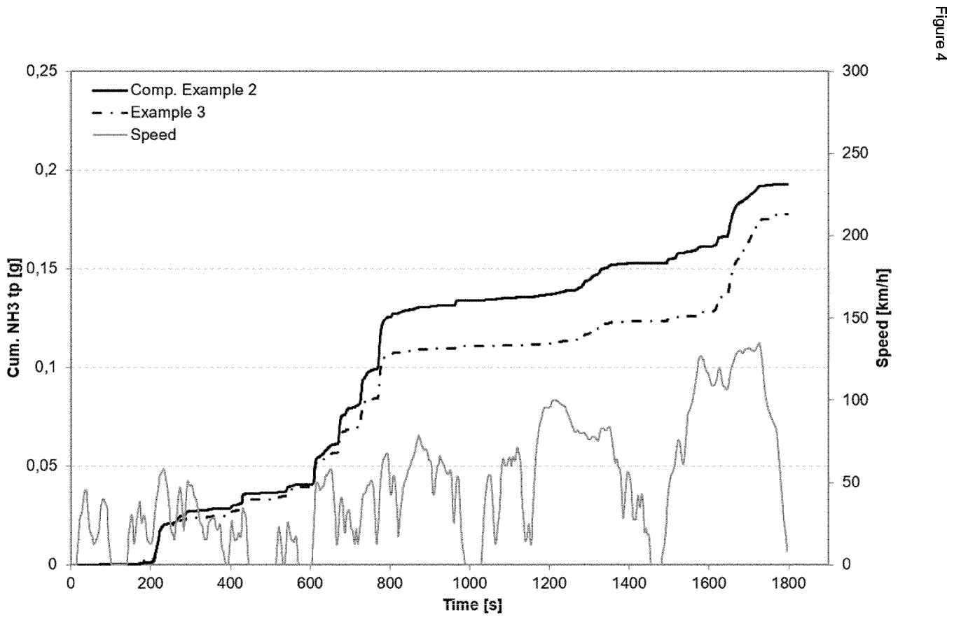

FIG. 5 shows the CO cumulated obtained with the systems of Example 3 and Comparative Example 2 after aging.

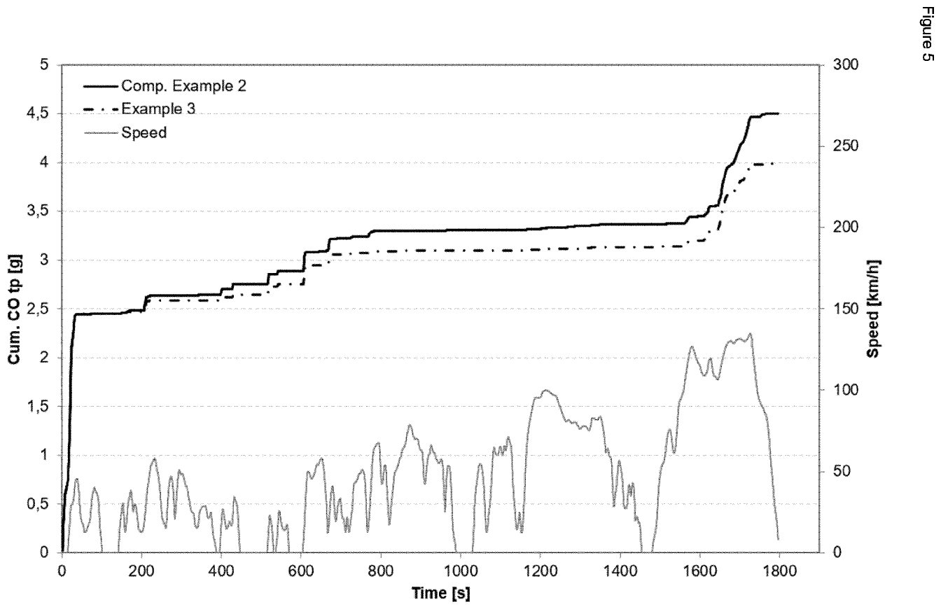

FIG. 6 shows the N₂O cumulated obtained with the systems of Example 3 and Comparative Example 2 after aging.

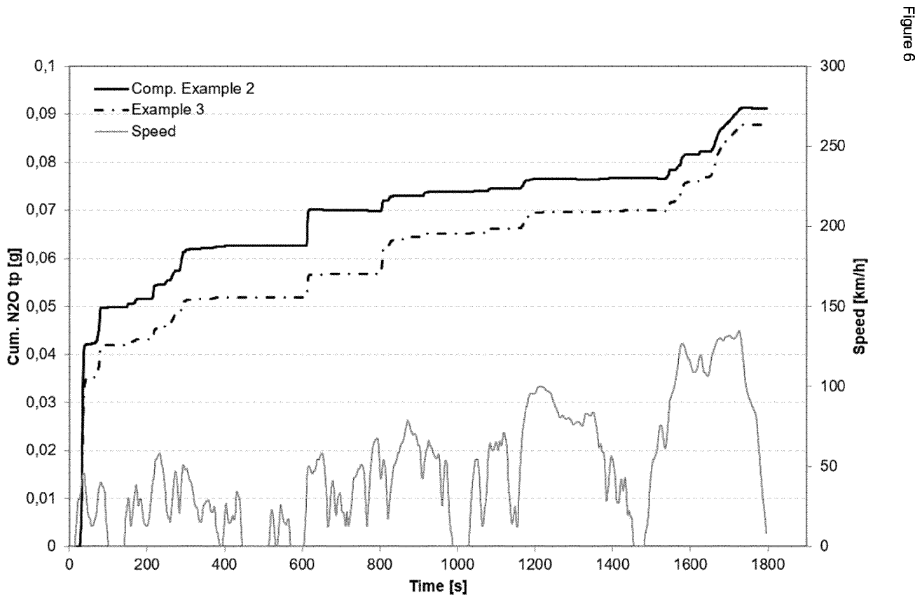

1. An exhaust gas treatment system for treating an exhaust gas stream exiting a gasoline engine, said exhaust gas treatment system having an upstream end for introducing said exhaust gas stream into said exhaust gas treatment system, wherein said exhaust gas treatment system comprises
(i) a first catalyst, being a three-way conversion catalyst, having an inlet end and an outlet end and comprising a coating disposed on a substrate, wherein the coating comprises a platinum group metal component supported on a porous oxidic material;
(ii) a second catalyst, being a four-way conversion catalyst, having an inlet end and an outlet end and comprising a coating disposed on a wall flow filter substrate, wherein the coating comprises a platinum group metal component supported on a porous oxidic material;
(iii) a third catalyst having an inlet end and an outlet end, wherein the third catalyst comprises a substrate and a coating for the selective catalytic reduction of NOx, wherein the SCR coating comprises a zeolitic material comprising one or more of Fe and Cu,
wherein at most 0.0001 weight-% of said SCR coating consists of platinum group metal;
wherein the first catalyst according to (i) is the first catalyst of the exhaust gas treatment system downstream of the upstream end of the exhaust gas treatment system and wherein the inlet end of the first catalyst is arranged upstream of the outlet end of the first catalyst;
wherein in the exhaust gas treatment system, the second catalyst according to (ii) is located downstream of the first catalyst according to (i) and wherein the inlet end of the second catalyst is arranged upstream of the outlet end of the second catalyst;
wherein in the exhaust gas treatment system, the third catalyst according to (iii) is located downstream of the second catalyst according to (ii) and wherein the inlet end of the third catalyst is arranged upstream of the outlet end of the third catalyst.

2. The exhaust gas treatment system of claim 1, wherein the porous oxidic material supporting the platinum group metal component of the coating of the first catalyst is selected from the group consisting of alumina, ceria, silica, zirconia, titania, a mixture of two or more thereof and a mixed oxide of two or more thereof, preferably selected from the group consisting of alumina, titania, zirconia, a mixture of two or more thereof and a mixed oxide of two or more thereof, more preferably selected from the group consisting of alumina, zirconia, a mixture of two thereof, and a mixed oxide of two thereof, more preferably is alumina.

3. The exhaust gas treatment system of claim 1, wherein the coating of the first catalyst further comprises an oxygen storage component, the oxygen storage component preferably comprising cerium, more preferably comprising one or more of a cerium oxide, a mixture of oxides comprising a cerium oxide and a mixed oxide comprising cerium, wherein the mixed oxide comprising cerium more preferably additionally comprising one or more of zirconium, yttrium, neodymium, lanthanum, hafnium, samarium and praseodymium, more preferably one or more of zirconium, yttrium, neodymium, lanthanum, and praseodymium, more preferably zirconium.

4. The exhaust gas treatment system of claim 3, wherein, in the coating of the first catalyst, the weight ratio of the porous oxidic material relative to the oxygen storage component as defined in claim 3 is in the range of from 1:1 to 10:1, preferably in the range of from 1:1 to 5:1.

5. The exhaust gas treatment system of claim 1, wherein the coating of the first catalyst further comprises an oxide of an alkaline earth metal, the alkaline earth metal preferably being selected from the group consisting of barium, strontium and magnesium, more preferably being selected from the group consisting of barium and strontium, more preferably being barium.

6. The exhaust gas treatment system of claim 1, wherein the coating of the second catalyst further comprises an oxygen storage component (OSC), the oxygen storage component preferably comprises cerium, more preferably comprises one or more of a cerium oxide, a mixture of oxides comprising a cerium oxide and a mixed oxide comprising cerium, wherein the mixed oxide comprising cerium more preferably additionally comprises one or more of zirconium, yttrium, neodymium, lanthanum, hafnium, samarium and praseodymium, more preferably one or more of zirconium, yttrium, neodymium, lanthanum, and praseodymium, more preferably zirconium.

7. The exhaust gas treatment system of claim 1, wherein the zeolitic material comprised in the SCR coating of the third catalyst is a 12-membered ring pore zeolitic material,
wherein the 12-membered ring pore zeolitic material preferably has framework type selected from the group consisting of BEA, MOR, FAU, GME, OFF, a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the SCR coating of the third catalyst has a framework type BEA.

8. The exhaust gas treatment system of claim 7, wherein the zeolitic material comprised in the SCR coating of the third catalyst is a 12-membered ring pore zeolitic material, the zeolitic material comprising Fe.

9. The exhaust gas treatment system of claim 1, wherein the third catalyst consists of the substrate and the SCR coating.

10. The exhaust gas treatment system of claim 1, wherein the third catalyst comprises an ammonia oxidation catalyst (AMOx) coating in addition to the SCR coating.

11. The exhaust gas treatment system of claim 10, wherein the SCR coating of the third catalyst comprises, preferably consists of, a zeolitic material, preferably having a framework type BEA, comprising iron and a non-zeolitic oxidic material, preferably ceria.

12. The exhaust gas treatment system of claim 10, wherein the AM Ox coating of the third catalyst comprises a platinum group metal, preferably one or more of Pt, Pd and Rh, more preferably one or more of Pt and Pd, more preferably Pt, and further comprises a zeolitic material comprising one or more of Fe and Cu, preferably a zeolitic material comprising Fe.

13. The exhaust gas treatment system of claim 10, wherein the AMOx coating of the third catalyst comprises a porous oxidic material, wherein the porous oxidic material is selected from the group consisting of titania, alumina, ceria, silica, zirconia, a mixture of two or more thereof and a mixed oxide of two or more thereof, preferably selected from the group consisting of titania, alumina and silica, more preferably is titania.

14. The exhaust gas treatment system of claim 13, wherein, in the AMOx coating, the weight ratio of said zeolitic material, comprising one or more of Fe and Cu, relative to the porous oxidic material is in the range of from 0.5:1 to 2:1, preferably in the range of from 0.75:1 to 1.5:1, more preferably in the range of from 1:1 to 1.25:1.

15. The exhaust gas treatment system of claim 10, wherein the AMOx coating is disposed on the substrate of the third catalyst over 98 to 100%, preferably 99 to 100%, more preferably 99.5 to 100%, of the substrate axial length, and the SCR coating is disposed on the AMOx coating over 98 to 100%, preferably 99 to 100%, more preferably 99.5 to 100%, of the substrate axial length

16. The exhaust gas treatment system of claim 1, wherein the third catalyst comprises an inlet zone comprising, preferably consisting of, the SCR coating and an outlet zone comprising, preferably consisting of, an ammonia oxidation catalyst coating; wherein the AMOx coating of the outlet zone comprises:
a first coat, the first coat comprising a platinum group metal supported on a porous oxidic material, preferably titania, and a zeolitic material comprising one or more of Fe and Cu, the first coat preferably further comprising a non-zeolitic oxidic material, wherein the non-zeolitic oxidic material more preferably comprises one or more of zirconia, alumina, ceria, titania, silica, and a mixed oxide comprising two or more of Zr, Al, Ce, Ti, and Si;
a second coat, the second coat comprising a zeolitic material comprising one or more of Fe and Cu, wherein at most 0.0001 weight-% of said first coat consist of platinum group metal;
wherein the first coat is disposed on the substrate over the length of the outlet zone and the second coat is disposed on the first coat over the length of the outlet zone; or wherein the second coat is disposed on the substrate over the length of the outlet zone and the first coat is disposed on the second coat over the length of the outlet zone.

17. The exhaust gas treatment system of claim 1, wherein the third catalyst comprises an oxidation catalyst coating in addition to the SCR coating; wherein the oxidation catalyst coating of the third catalyst comprises a platinum group metal and wherein at most 0.01 weight-% of the oxidation catalyst coating of the third catalyst consist of zeolitic material.

18. A method for the simultaneous selective catalytic reduction of NOx, the oxidation of a hydrocarbon, the oxidation of nitrogen monoxide and the oxidation of ammonia, comprising
(1) providing an exhaust gas stream from a gasoline engine comprising one or more of NOx, ammonia, nitrogen monoxide and a hydrocarbon;
(2) passing the exhaust gas stream provided in through the exhaust gas system according to claim 1.
